(19) United States
(12) Patent Application Publication
(10) Pub. No.: US 2014/0292471 A1
(43) Pub. Date: Oct. 2, 2014

(54) TRANSFORMER

(71) Applicant: Bao Hui Science & Technology Co., Ltd., Long Nan (CN)

(72) Inventors: Kwok Pun HO, Honk Kong (HK); Chi Hung CHEUNG, Hong Kong (HK)

(73) Assignee: Bao Hui Science & Technology Co., Ltd., Long Nan (CN)

(21) Appl. No.: 14/194,349

(22) Filed: Feb. 28, 2014

Related U.S. Application Data
(60) Provisional application No. 61/807,406, filed on Apr. 2, 2013.

(51) Int. Cl. H01F 27/38

(52) U.S. Cl. CPC H01F 27/385
USPC 336/84 C

(57) ABSTRACT

A transformer includes at least one primary interface winding, at least one secondary interface winding, in which at least part of the primary interface winding is formed on an insulating device or insulator. At least part of the primary interface winding and at least part of the secondary interface winding collectively form a noise reduction mechanism.

### CROSS REFERENCE TO RELATED APPLICATION

This application claims priority from U.S. Provisional Patent Application No. 61/807,406 filed on 2 Apr. 2013, the content of which are fully incorporated herein.

### FIELD OF THE INVENTION

This invention relates to transformers, such as power supply transformers, with common mode noise reduction mechanism.

### BACKGROUND OF THE INVENTION

Power supply transformer windings normally consist of one or more primary windings, one or more auxiliary windings and one or more secondary windings wound on a mechanical support part. The windings are normally wound onto a bobbin, and insulation (such as a tape) is normally provided between the windings for safety insulation or isolation purpose. The process of winding such windings on the support part is still very manual, and hence the manufacturing cost is high. Adding on the material cost, the total production cost of a conventional transformer is thus very high.

It is also mandatory for a power supply to meet international noise emission and immunity regulatory requirements. It is therefore necessary to implement a number of noise reduction or prevention techniques in the power supply design. The power supply transformer is one of the major noise sources and it is preferred to reduce the noise sources as much as possible in the transformer design so as to reduce the number of filters to be added onto the power supply. The number of turns of each of the primary winding, secondary winding and the auxiliary winding mainly relate to power supply topology, power supply specification and the transformer design itself, such as the ferrite size. The winding constructions of the primary winding, auxiliary winding and secondary winding may be of one layer or of a plural number of layers. The primary interface winding is the winding layer of the primary winding and/or the auxiliary winding directly facing the secondary interface winding; and the secondary interface winding is the winding layer of the secondary winding directly facing the primary interface winding. One very common method to reduce noise is to make the interface voltage swing (or noise or common mode noise) between the secondary interface winding (which could be a part or the whole of the secondary winding) and the primary interface winding (which could be a part or the whole of the primary winding and/or a part or the whole of the auxiliary winding) of the transformer below a predefined desirable level. However, due to the requirement for very good physical alignment, this would complicate the process of manufacturing the transformer and hence further increase the materials cost as well as the manufacturing cost.

There are other variations of transformer design that use multiple layers of printed circuit board (PCB) and/or several pieces of PCBs stacked together with printed circuits on it to form the transformer windings. However, the disadvantages of such arrangements are that the cost of multiple layers of PCBs is very expensive, and that, due to the limited thickness of the conductive circuits printed on the PCB, copper loss of the printed circuit board windings is usually higher than conventional transformer windings using copper wire.

It is thus an object of the present invention to provide a transformer having a simple construction while the low common mode noise requirement can still be achieved, and hence the cost of the transformer can be reduced.

### SUMMARY OF THE INVENTION

According to the present invention, there is provided a transformer including at least one primary interface winding, and at least one secondary interface winding, wherein at least part of said primary interface winding is formed on an insulating device or insulator, and wherein at least part of said primary interface winding and at least part of said secondary interface winding collectively form a noise reduction mechanism.

### BRIEF DESCRIPTION OF THE DRAWINGS

Transformers according to various embodiments of the present invention will now be described, by way of examples only, with reference to the accompanying drawings, in which:

FIG. 1 shows a typical switching mode power supply circuit;

FIG. 2 shows a cross section view of a typical transformer with primary, auxiliary and secondary windings, and with insulation tape added between the windings, but not showing a ferrite core to be added after the winding process;

FIG. 3 is a schematic diagram of a transformer with one primary winding, one auxiliary winding and one secondary winding, according to a first embodiment of the present invention;

FIG. 4 is a front view of a transformer according to the embodiment of FIG. 3;

FIG. 5 is a side view of the transformer of FIG. 4;

FIG. 6 is an exploded view of the transformer of FIG. 4;

FIG. 7 is another exploded view of the transformer of FIG. 4;

FIG. 8 is a schematic diagram of a transformer with one primary winding, one auxiliary winding split into two serious windings and one secondary winding, according to a second embodiment of the present invention;

FIG. 9 is a front view of a transformer according to the embodiment of FIG. 8;

FIG. 10 is a rear view of the transformer of FIG. 9;

FIG. 11 is a side view of the transformer of FIG. 9;

FIG. 12 is an exploded view of the transformer of FIG. 9;

FIG. 13 is another exploded view of the transformer of FIG. 9;

FIG. 14 is a schematic diagram of a transformer having two primary windings, two auxiliary windings and one secondary winding, according to a third embodiment of the present invention;

FIG. 15 is a front view of a transformer according to the embodiment of FIG. 14;

FIG. 16 is a rear view of the transformer of FIG. 15;

FIG. 17 is a side view of the transformer of FIG. 15;

FIG. 18 is a rear view of the partial assembly of the transformer of FIG. 15, showing part of a primary winding attached to a single sided PCB with an auxiliary winding printed on it;

FIG. 19 is a side view of the partial assembly of the transformer of FIG. 18, showing the part of one primary winding attached to a single sided PCB with auxiliary winding printed on it;

FIG. 20 is a front view of another PCB used in the transformer of FIG. 15, having another auxiliary winding printed on it;

FIG. 21 is a rear view of the PCB shown in FIG. 20;

FIG. 22 is an exploded view of the transformer of FIG. 15;

FIG. 23 is another exploded view of the transformer of FIG. 15;

FIG. 24 is a schematic diagram of a transformer having one primary winding, one auxiliary winding and one secondary winding, according to a further embodiment of the present invention;

FIG. 25 is a front view of a transformer according to the embodiment of FIG. 24;

FIG. 26 is a rear view of the transformer of FIG. 25;

FIG. 27 is a side view of the transformer of FIG. 25;

FIG. 28 is a transparent view of overmolded secondary winding with auxiliary winding printed on it;

FIG. 29 is a front view of a complete overmolded winding assembly, i.e. overmolded secondary winding with auxiliary shield winding printed thereon and with the primary winding attached thereto;

FIG. 30 is a side view of the complete overmolded winding assembly;

FIG. 31 is an exploded view of the transformer of FIG. 25;

FIG. 32 is another exploded view of the transformer of FIG. 25;

FIG. 33 is a schematic diagram of a transformer having two primary windings, two auxiliary windings and one secondary winding, according to a yet further embodiment of the present invention;

FIG. 34 is a front view of a transformer according to the embodiment of FIG. 33;

FIG. 35 is a rear view of the transformer of FIG. 34;

FIG. 36 is a side view of the transformer of FIG. 34;

FIG. 37 is a transparent front view of an overmolded secondary winding with one auxiliary winding printed on the front side;

FIG. 38 is a transparent rear view of the overmolded secondary winding of FIG. 37 with another auxiliary winding printed on the rear side;

FIG. 39 is a side view of a complete overmold winding assembly of the transformer of FIG. 34, comprising an overmold secondary winding, one auxiliary winding printed on each side of the overmold, and one primary winding attached to each side of the overmold;

FIG. 40 is an opposite side view of the overmold winding assembly of FIG. 39;

FIG. 41 is an exploded view of the transformer of FIG. 34;

FIG. 42 is another exploded view of the transformer of FIG. 34;

FIG. 43 is a schematic diagram of a transformer having one primary winding, one auxiliary winding and one secondary winding, according to a still further embodiment of the present invention;

FIG. 44 is a front view of a transformer according to the embodiment of FIG. 43;

FIG. 45 is a bottom view of the transformer of FIG. 44;

FIG. 46 is a side view of the transformer of FIG. 44;

FIG. 47 is a side view of a single slot bobbin wound with primary winding and having the auxiliary winding printed on one side;

FIG. 48 is a front view of the single slot bobbin of FIG. 47;

FIG. 49 is a rear view of the single slot bobbin of FIG. 47;

FIG. 50 is a side view of the single slot bobbin of FIG. 47, with a bobbinless secondary winding attached thereto;

FIG. 51 is an exploded view of the transformer of FIG. 44;

FIG. 52 is another exploded view of the transformer of FIG. 44;

FIG. 53 is a schematic diagram of a transformer having one primary winding, two auxiliary windings and two secondary winding, according to a further embodiment of the present invention;

FIG. 54 is a front view of a transformer according to the embodiment of FIG. 53;

FIG. 55 is a side view of the transformer of FIG. 54;

FIG. 56 is a rear view of an auxiliary winding PCB of the transformer of FIG. 54, showing a conductive shielding pattern;

FIG. 57 is a front view of an auxiliary winding PCB of the transformer of FIG. 54, showing the auxiliary winding pattern;

FIG. 58 is a side view of the auxiliary winding PCB of the transformer of FIG. 54, having a primary winding attached thereto;

FIG. 59 is an exploded view of the transformer of FIG. 54;

FIG. 60 is another exploded view of the transformer of FIG. 54;

FIG. 61 is a schematic diagram of a transformer having one primary winding, two auxiliary windings and one secondary winding, according to a still further embodiment of the present invention;

FIG. 62 is a front view of a transformer according to the embodiment of FIG. 61;

FIG. 63 is a side view of the transformer of FIG. 62;

FIG. 64 is a front view of the bobbin used in the transformer of FIG. 62;

FIG. 65 is a side view of the bobbin used in the transformer of FIG. 62;

FIG. 66 is a front view of a partial winding assembly used in the transformer of FIG. 62;

FIG. 67 is a side view of the partial winding assembly used in the transformer of FIG. 62;

FIG. 68 is an exploded view of the transformer of FIG. 62;

FIG. 69 is another exploded view of the transformer of FIG. 62;

FIG. 70 is a schematic diagram of a transformer having one primary winding, two auxiliary windings and one secondary winding, according to a yet further embodiment of the present invention;

FIG. 71 is a front view of a transformer according to the embodiment of FIG. 70;

FIG. 72 is a side view of the transformer of FIG. 71;

FIG. 73 is a front view of a PCB used in the transformer of FIG. 71;

FIG. 74 is a front view of a partial winding assembly used in the transformer of FIG. 71;

FIG. 75 is a rear view of the partial winding assembly of FIG. 74;

FIG. 76 is an exploded view of the transformer of FIG. 71;

FIG. 77 is another exploded view of the transformer of FIG. 71;

FIG. 78 is a schematic diagram of a flyback switching power supply circuit; and

FIG. 79 shows one method of determining whether the interface voltage swing between two windings in the transformer shown in FIG. 78 is below a predefined desired level.

### DESCRIPTION OF THE EMBODIMENTS

To power electrical and/or electronic devices such as televisions, computers, printers, routers etc. or to charge batteries of portable devices such as mobile phones, tablets and laptops, it is necessary to convert the AC mains voltage to a lower voltage. One typical way to achieve this is to use switching power supplies. There are many switching power supplies topology such as flyback, forward, buck and LLC etc. Regardless of the topology to be used, a transformer is required to convert the input voltage to another voltage. Depending on the power supply specification and topologies to be used and many other constraints, the design and construction of each transformer may be very different. A typical transformer design comprises a primary winding connected to the input side in the power supply circuit, a secondary winding connected to the output side in the power supply circuit, and an auxiliary winding for providing power to drive electronic components on the primary side circuits. As an example, FIG. 1 is a simplified and typical power supply circuit using flyback topology, which comprises a transformer 1 with a primary winding 2, an auxiliary winding 3 and a secondary winding 4.

To comply with international safety regulations, the primary winding and the auxiliary winding are electrically isolated from the secondary winding. In addition, certain minimum safety insulation, creepage and clearance distances must also be fulfilled. This is usually achieved by proper transformer construction, using properly designed bobbin with suitable material, and using insulation materials such as tapes, tubes and insulation copper wires which are approved by international safety agencies.

As an example, one conventional transformer design would have the windings wound on a bobbin and have the winding wires terminated on pins inserted to the bobbin. Normally, enamel copper wires would be used for the primary winding and auxiliary winding. For the secondary winding, either enamel copper wires or safety approved triple insulation wires are normally used.

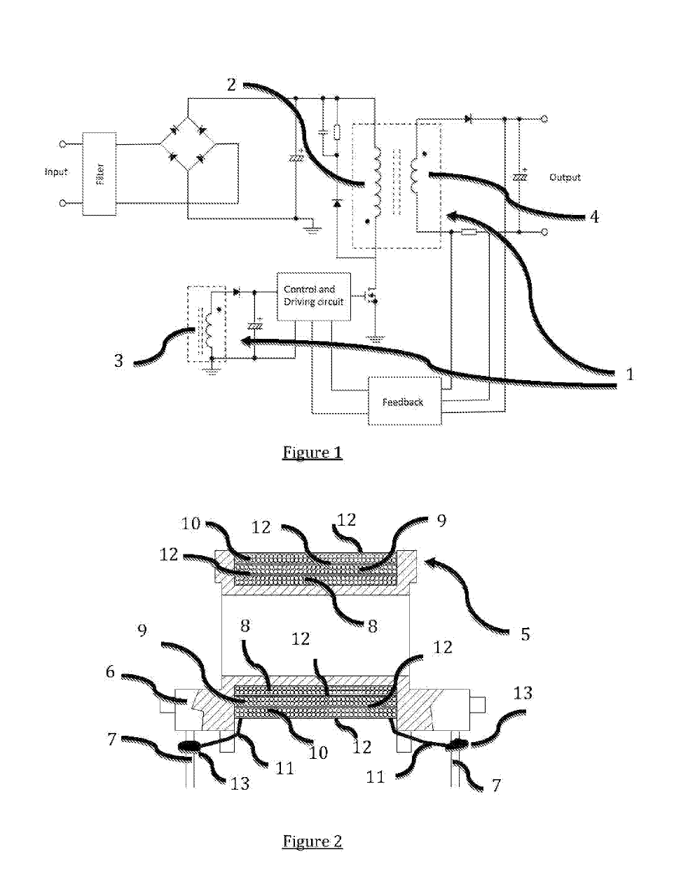

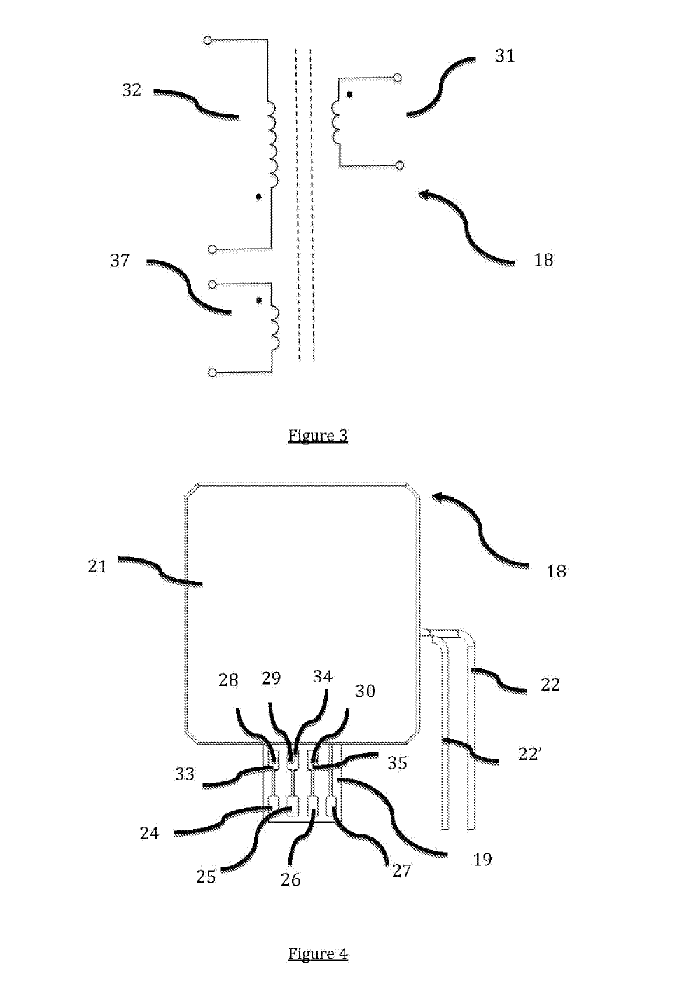

As shown in FIG. 2, which is a cross sectional view of a typical transformer 5 comprising a bobbin 6, several terminal pins 7, a primary winding 8, an auxiliary winding 9, a secondary winding 10 using triple insulated wire, insulation tape 12. The windings 8, 9 and 10 are terminated to the several terminal pins 7 with the associated terminating wires 11 normally connected to the associated terminating points 13 by using solder. For safety and electrical insulation purposes, insulation tapes 12 are normally added between the primary winding 8, auxiliary winding 9 and secondary winding 10. A pair of ferrite core (not shown) would be added to complete the transformer after the winding processes are completed.

Since the transformer is one of the noise sources of switching mode power supplies, it is necessary to provide a proper design of the transformer to reduce generation of noise. One very common method to achieve this is to make the interface voltage swing or noise between the secondary interface winding (which could be a part or the whole of the secondary winding) and the primary interface winding (which could be a part or the whole of the primary winding and/or a part or the whole of the auxiliary winding) of the transformer below a predefined desirable level. It is quite common to use a part or the whole of the auxiliary winding as a primary interface winding (also sometimes referred to as shield winding or noise cancellation/reduction winding/coil in other parts of this document) to interface with the secondary interface winding. However, due to the need for very good physical alignment to achieve desirable noise reduction performance, this would complicate the manufacturing process of the transformer and hence increase the materials cost as well as the manufacturing cost. The construction of the transformer itself is also completed, and hence the cost of the transformer is high.

In the present invention, several embodiments are deployed with multiple coil windings transformers having a simple construction while low common mode noise requirement can still be achieved, and hence the cost of the transformer can be much reduced. Broadly speaking, the several constructions of transformers according to the present invention to be described are:

1. coil windings being attached to an insulator after winding; and

2. coil windings being molded by plastic encapsulation; and

3. coil windings being wound on a slotted bobbin.

Instead of winding the transformer winding coils on a conventional transformer bobbin and using insulation tape for isolation or safety insulation between windings, a design of transformers according to the present invention is to use bobbinless coil(s) as primary windings, another bobbinless coil(s) as secondary winding, and one or more primary interface winding(s) are formed directly (e.g. by printing, etching or engraving) on the surface of an insulator with electric conductive material whereas the insulator is used as safety insulation between the primary and secondary windings. Each winding may consist of one single conductor or a plurality of conductors. The primary winding, insulator with auxiliary winding formed on it and the secondary winding are assembled together with a simple sandwich like construction.

An alternative design is to encapsulate one or more of the windings, preferably the secondary winding, by plastic molding material with the primary bobbinless coil winding attached to the molding coil winding surface, and the auxiliary winding and/or noise shielding is formed (e.g. by printing, etching or engraving) on the surface of the plastic molding material with electric conductive material. The windings and the encapsulated part (with or without circuit printed on it) are assembled together with a very simple sandwich-like construction.

Another alternative design is to wind the primary winding onto a slotted bobbin, and having the auxiliary winding formed (e.g. by printing, etching or engraving) on the external surface of the slotted bobbin to which the secondary winding is attached. Insulation tape can be omitted or reduced as the safety insulation distance is maintained by the thickness of the bobbin flanges as well as the creapage distance along the flange between the two windings.

Based on the above three basic constructions, different embodiment variations can be created by making choices from the alternatives listed below:

1. sandwich alternatives—sandwiched, non-sandwiched;

2. insulation alternatives—insulation sheet, insulator, PCB, overmold, slotted bobbin;

3. noise cancellation coil alternatives—printed, etched, engraved; and

4. primary and secondary alternatives—bobbinless enamel wire pancake, bobbinless triple insulated wire pancake, wound inside slot.

For the first construction with the coil windings attached to an insulator after winding, it is realized by Embodiments 1, 2, 3, 4, 5 and 6 described below as typical examples. The secondary interface winding can be a part or the whole of the secondary winding. If the secondary winding has a plural number of winding layers, then the secondary interface winding is the part of the secondary winding directly facing the primary auxiliary winding. For the purpose of easier illustration of these embodiments, unless otherwise specified, the secondary interface winding is assumed to be the whole of the secondary winding, as the drawings show that the winding has one single layer of winding construction. Because of this simplified assumption, the terms “secondary winding” and “secondary interface winding” may be used interchangeably in the description of these embodiments. It is important to note that, in practice, the whole secondary winding may have a plural number of conductors and a plural number of winding layers. This is because the secondary winding usually needs to carry high electrical current in the power supply circuit, and a thick conductor or a plural number of conductors are normally used as secondary winding to minimize the electrical conduction loss. In addition, because a thick conductor or a plural number of conductors are used and the winding window inside a transformer is limited, a plural number of winding layers are normally required to wind the required number of turns of the secondary winding.

### Embodiment 1

This is the simplest form of the first construction comprising a bobbinless primary, noise cancelling coil on a single sided printed circuit board (PCB) and facing secondary, bobbinless triple insulated secondary coil winding.

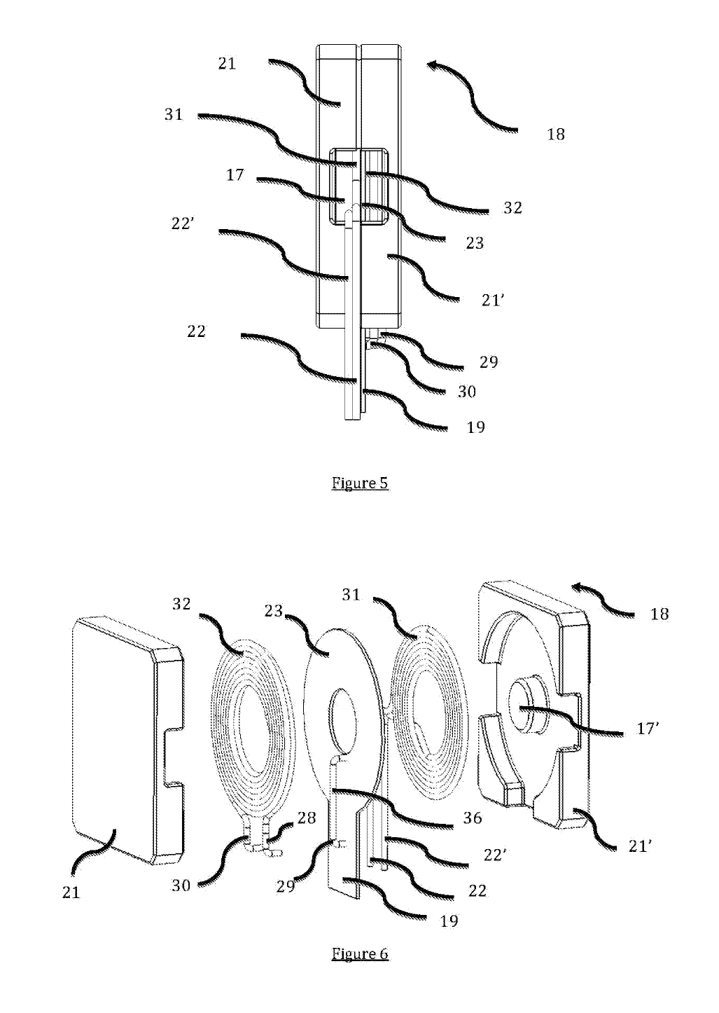

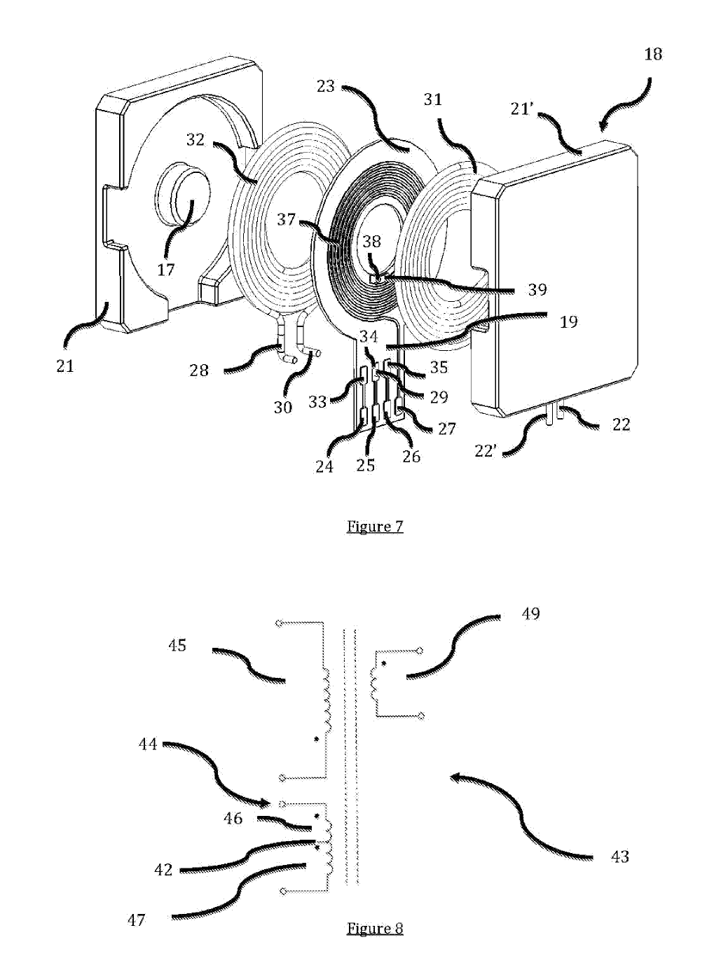

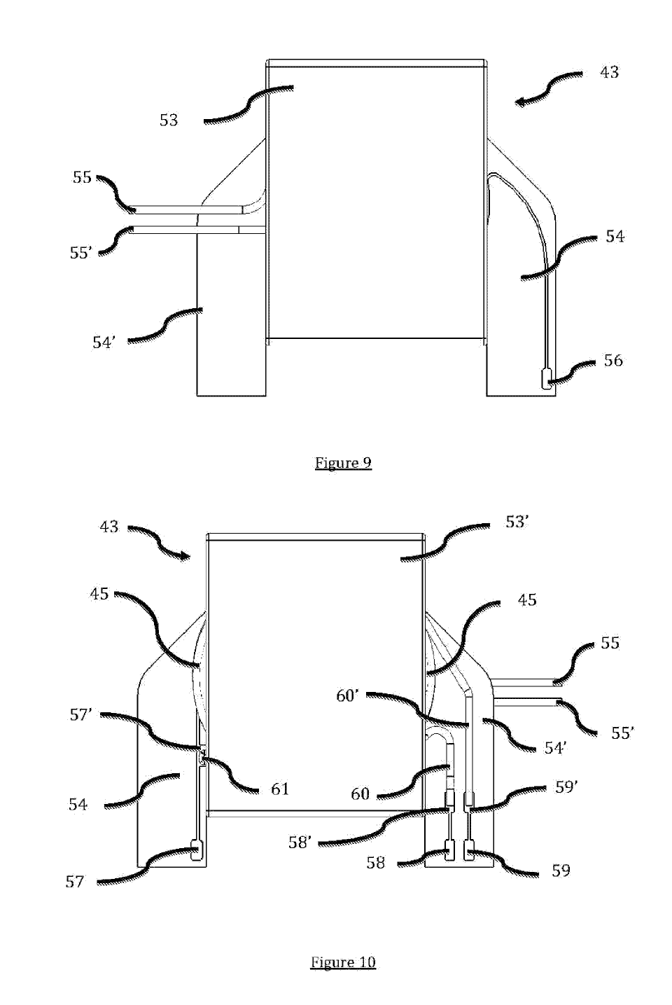

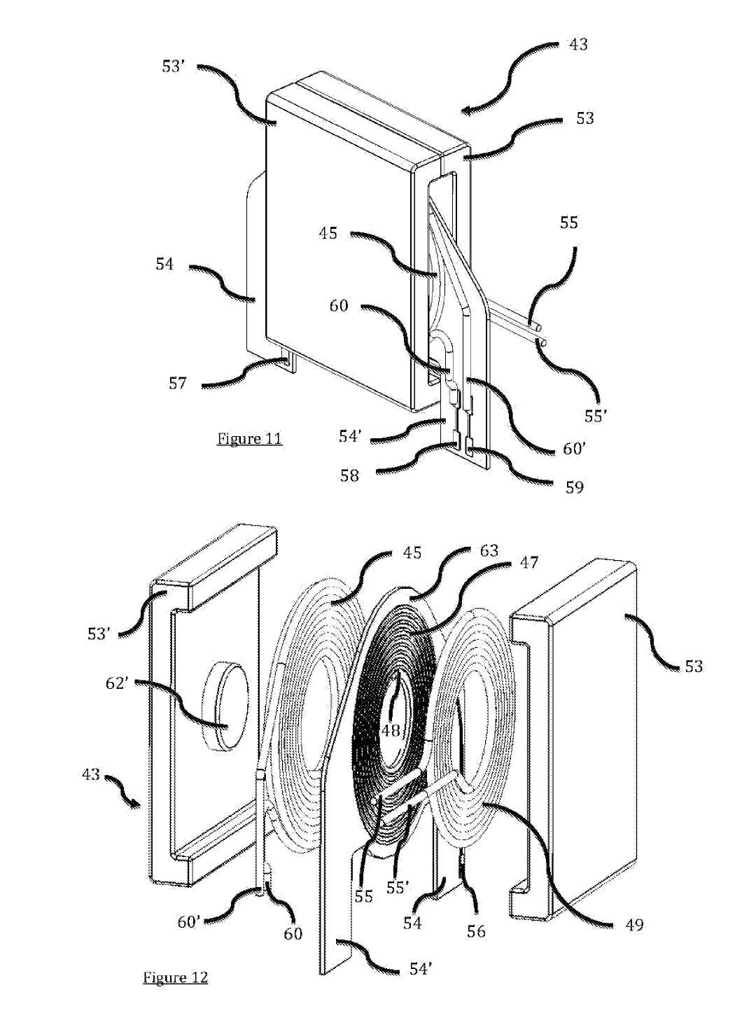

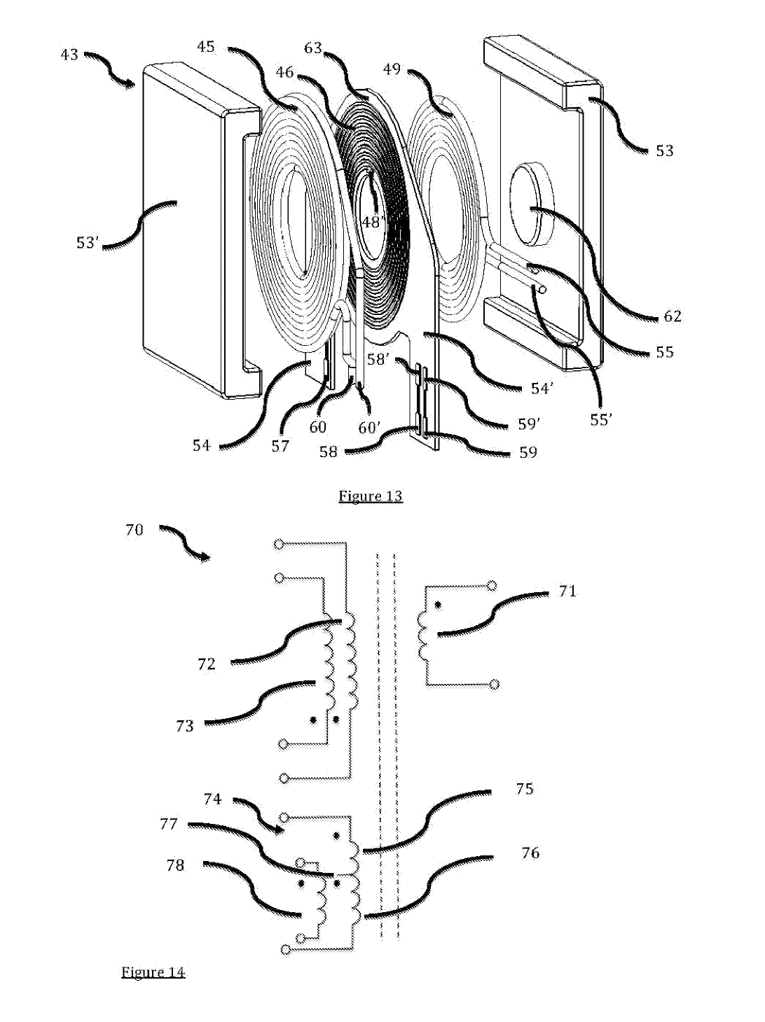

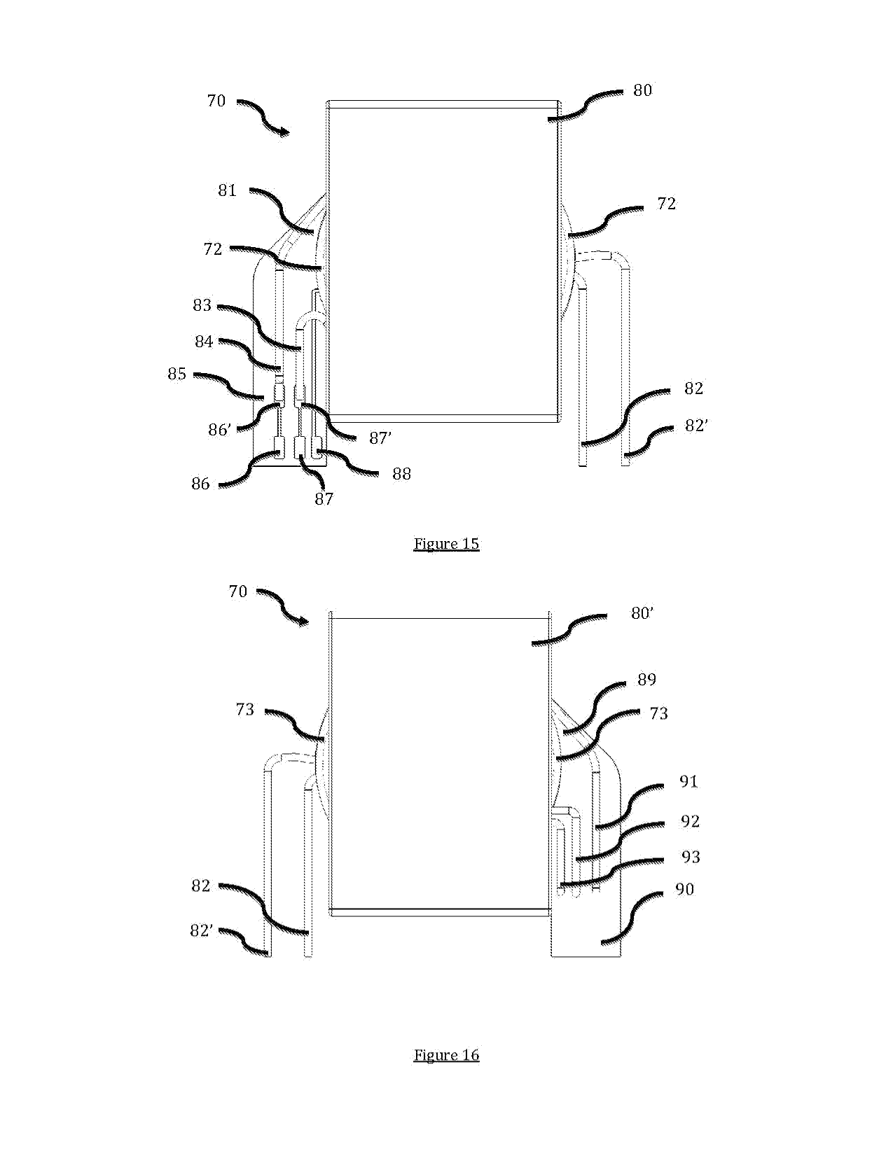

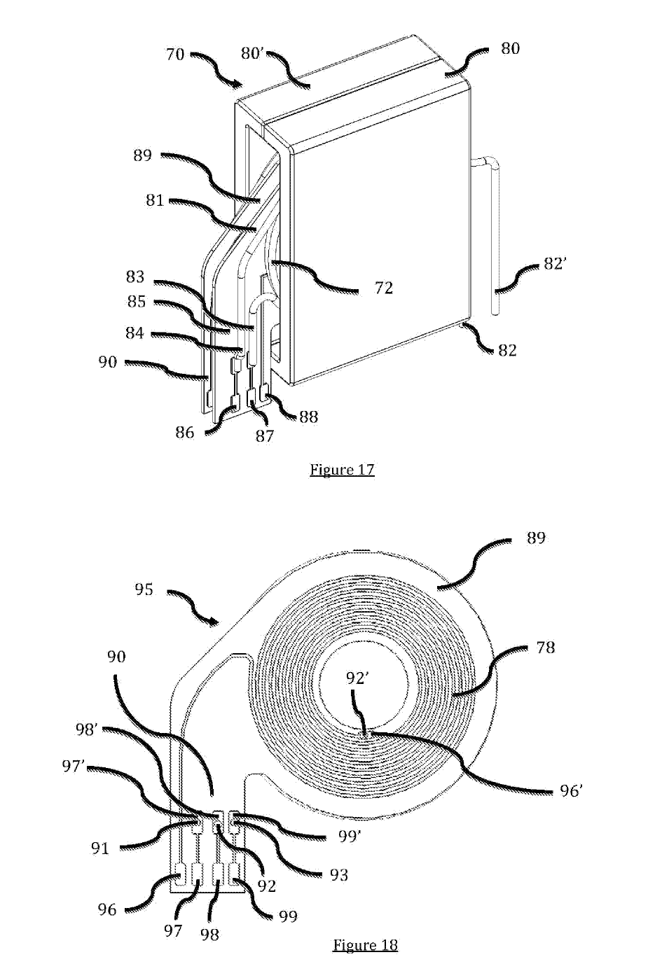

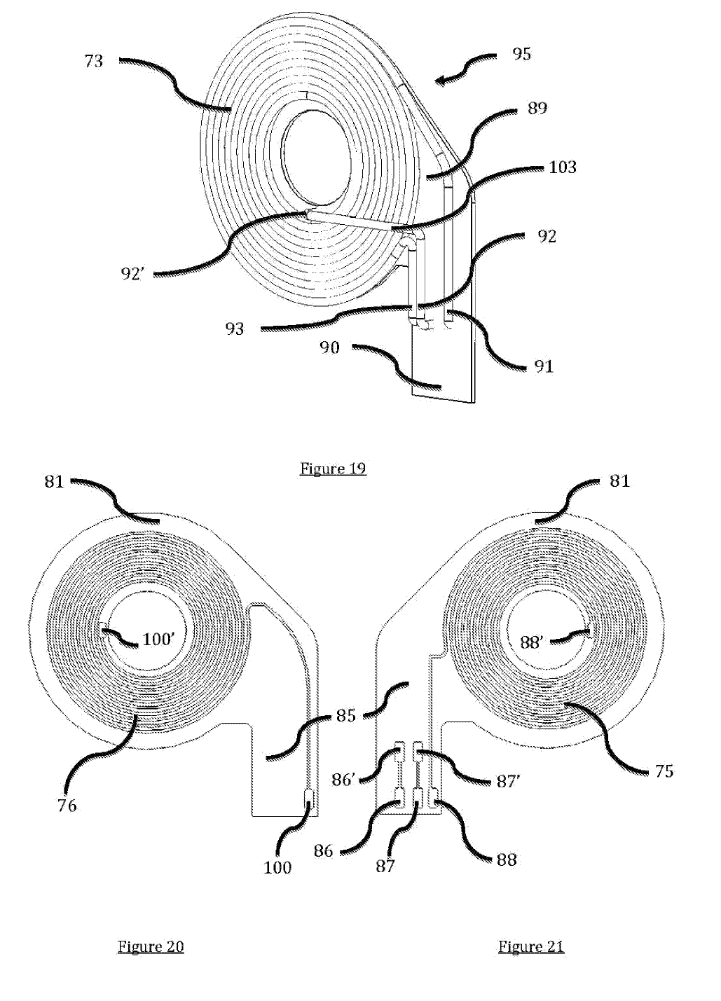

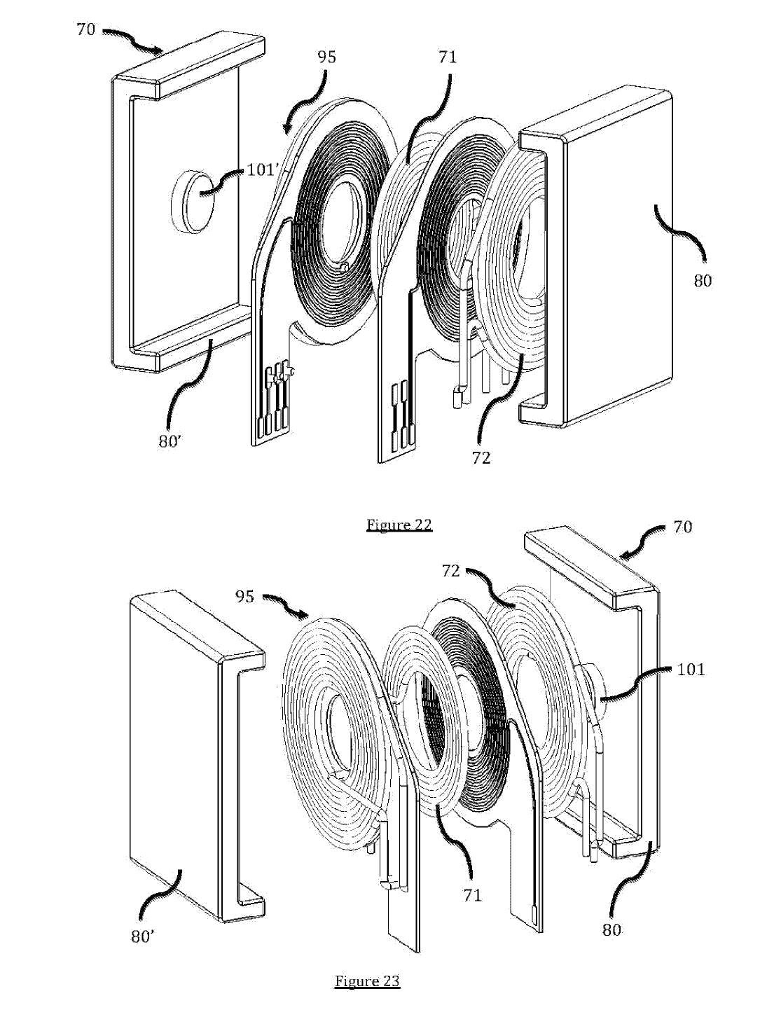

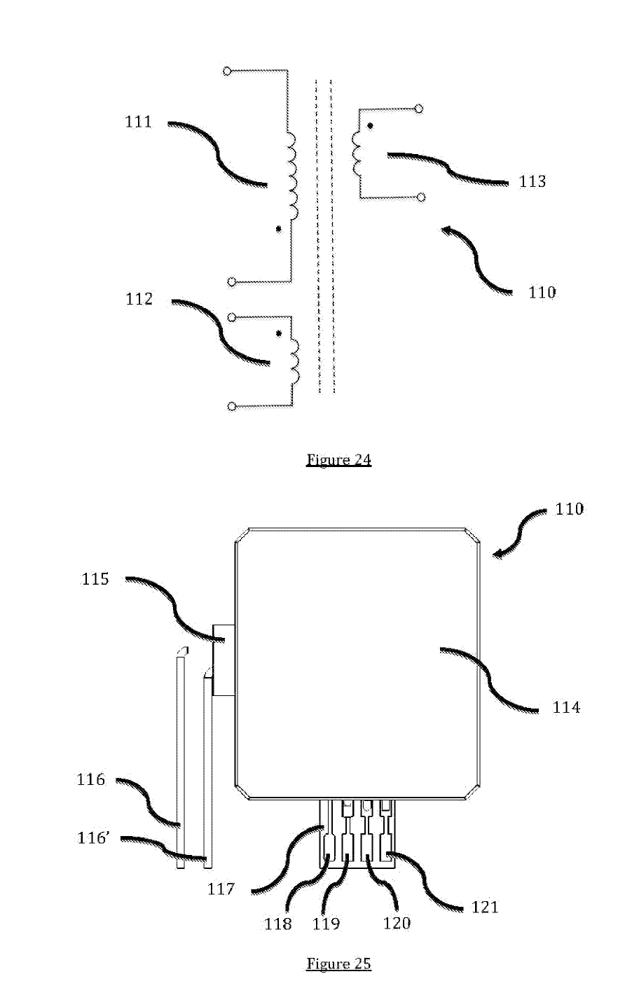

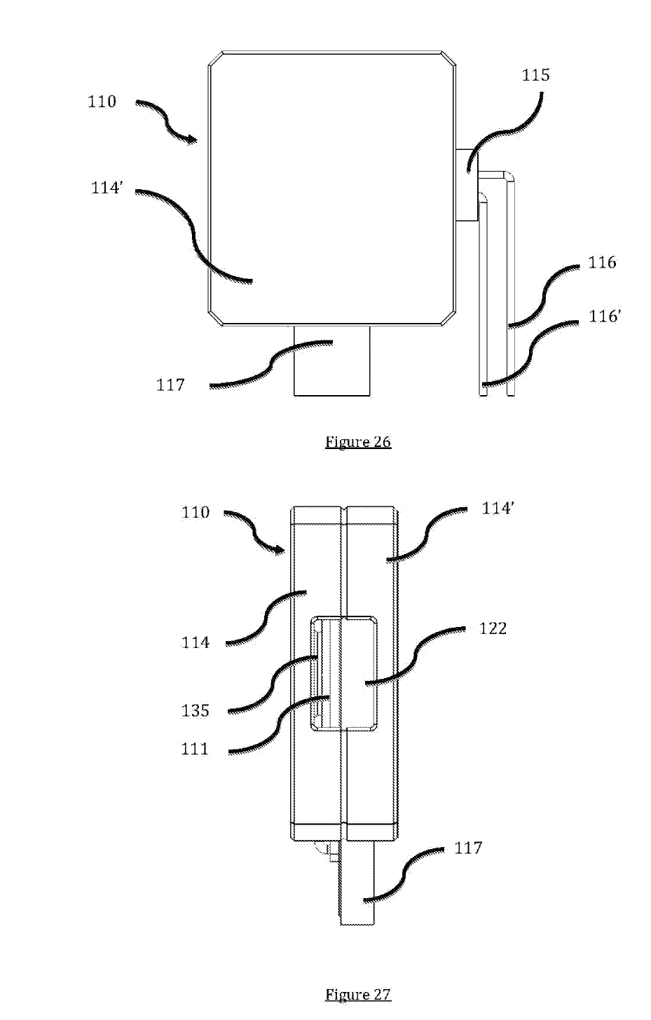

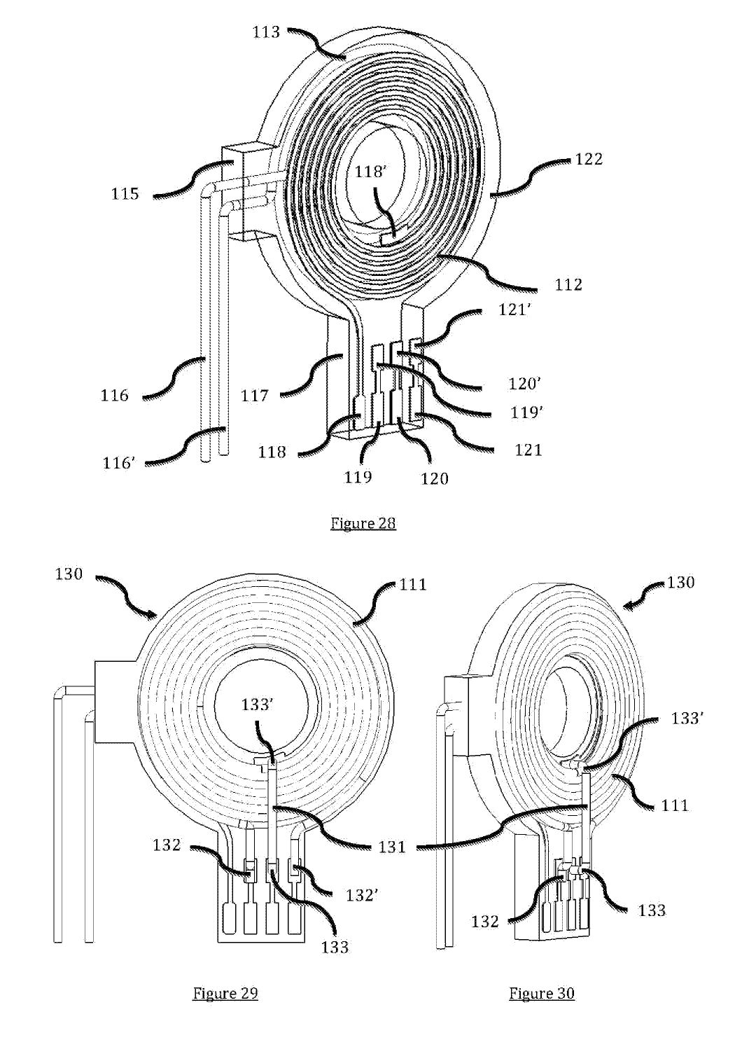

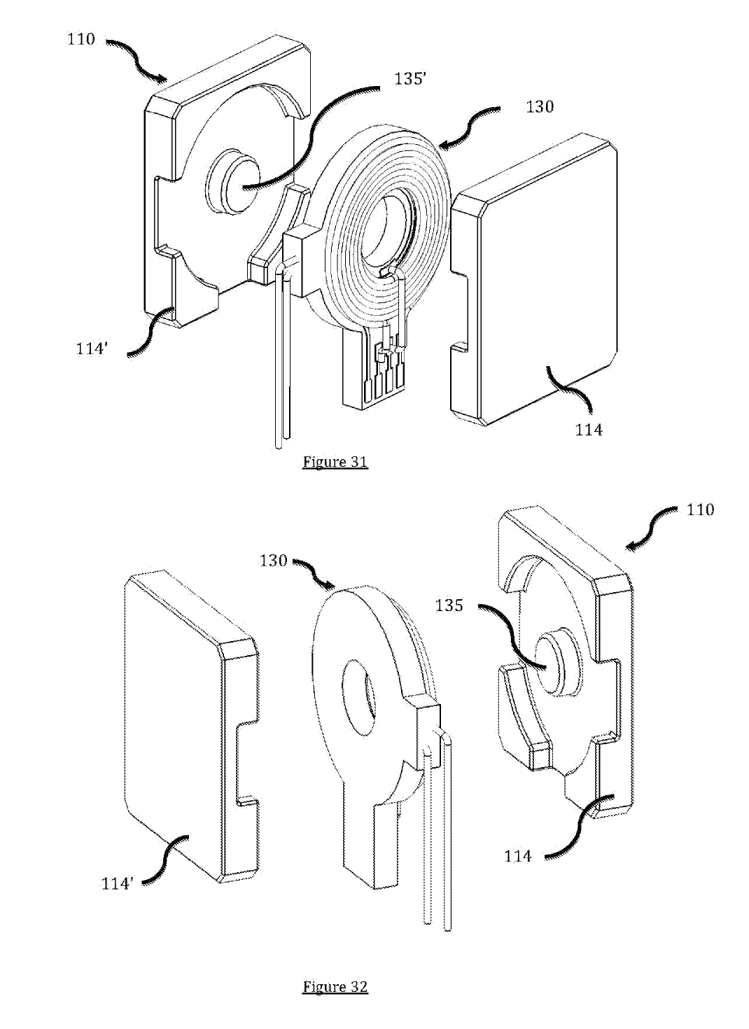

FIG. 3 is a typical electrical schematic diagram showing a transformer 18 with a primary winding 32, an auxiliary winding 37, and a secondary winding 31. The auxiliary winding 37 forms a primary interface winding and the secondary winding 31 forms a secondary interface winding.

FIGS. 4 to 7 show a typical construction of the transformer 18 of Embodiment 1. Depending on the choice of shape of the ferrites, which can be rectangular, circular or any other practical shapes, the insulator and winding shapes are also accommodated accordingly to allow all parts to be aligned and assembled together properly to form a transformer.

FIGS. 4 to 7 show a transformer 18 using two rectangular ferrite halves 21 and 21′ with a respective circular ferrite core center 17, 17′. The insulator shown in Embodiment 1 is a single sided PCB 23 having an optional extended part 19 at the bottom. The extended part 19 is for connecting the primary winding 32 and the auxiliary winding 37 to the interface component, preferably to be the main board (not shown) of the power supply (not shown).

The auxiliary winding 37 that forms the shield winding is formed (such as by printing) usually in spiral shape, by using a conductive material, which is usually copper for printed circuit board (while other conductive paintings or materials or conductive carbon materials may also be considered), on one side of the PCB 23. One winding end 27 of the auxiliary winding 37 is located at the extended PCB part 19 for external interface connection purpose. Another winding end 39 of the auxiliary winding 37 is located at the inner spiral. The winding end 39 is electrically connected to an electrical connection point 34 via an electrical conductor 36 located on the side of the PCB 23 opposite to the side having the auxiliary winding 37. The electrical conductor 36 may be a wire if the PCB 23 is single sided as shown in the drawings, but it may be another printed conductor on the PCB 23 if the PCB 23 is a double-sided board. It should be understood that these possible alternatives are applicable to other embodiments even if not explicitly mentioned or discussed in relation to the other embodiments. One end 38 of the electrical conductor 36 is electrically connected to the auxiliary winding end 39, while the other end 29 of the electrical conductor 36 is electrically connected to an electrical conductive printing pad 34. The electrical connection of the electrical conductive printing pad 34 is further extended to another electrical conductive printing pad 25 located at the extended PCB part 19 for external electrical interface connection purpose.

The primary winding 32, which is usually wound with safety approved enamel wire, is preferably to be wound in a spiral shape having a one-layer or multi-layer construction. The primary winding would usually have multiple winding layers because the primary winding would normally have many number of turns whereas the winding window inside the transformer is limited, which makes a single-layer primary winding construction difficult. The primary winding 32 is attached to the side of the PCB 23 opposite to the auxiliary winding 37. One winding end 28 of the primary winding 32 is electrically connected to an electrical conductive printing pad 33 on the PCB 23, whereas another winding end 30 of the primary winding 32 is electrically connected to an electrical conductive printing pad 35 on the PCB 23. The electrical conductive printing pads 33 and 35 are further extended to another respective electrical conductive printing pad 24 and 26 located at the extended PCB part 19 for external electrical interface connection purpose. Sufficient functional clearance between the connection pads and the windings is required for reliability purpose.

The secondary winding 31, which is usually wound with safety approved triple insulation wire for safety insulation purpose, is preferably to be wound in a spiral shape (also known as pancake shape) having one layer only, but may be multi-layers if necessary, depending on whether the secondary interface winding is just part of the secondary winding or the complete secondary winding. The secondary winding 31 is attached as close as possible to the side of the PCB 23 having the printed auxiliary winding 37. The winding ends 22 and 22′ are preferably extended freely and terminate directly to the electrical interface component (not shown) of the power supply board (not shown).

For best noise cancellation or noise reduction performance, the number of turns and shape of the printed auxiliary winding 37 (which is also the primary interface winding in this embodiment) together with the secondary winding 31 (which is also the secondary interface winding in this embodiment, as the secondary winding 31 has only one winding layer, which means that the secondary interface winding is the whole of the secondary winding 31) are preferably to be designed and assembled such that the interface voltage swing between the two windings is below a predefined desirable level. The number of turns of each of the primary winding, secondary winding and the auxiliary winding mainly relate to power supply design, power supply specification and the transformer design itself. The primary interface winding is the winding layer of the primary winding or the auxiliary winding directly facing the secondary interface winding; and the secondary interface winding is the winding layer of the secondary winding directly facing the primary interface winding. Usually the number of turns of the primary interface winding is from substantially 80% to substantially 120% of the number of turns of the secondary interface winding. This general rule applies to all other embodiments even if not explicitly specified in relation to the other embodiments.

In brief the construction of Embodiment 1 is the PCB 23 sandwiched between the two ferrite halves 21, 21′. There is a shield winding 37 (which is the primary interface winding in this embodiment) printed on the PCB 23 with a, preferably noise voltage swing sufficiently balanced, secondary winding 31 (which is the secondary interface winding in this embodiment) properly positioned and closely attached to it. A primary winding 32 is attached to the other side of the PCB 23. All the parts are fixed together by proper adhesive or fixing materials (not shown) during the manufacturing process.

### Embodiment 2

A transformer according to Embodiment 2 includes a bobbinless primary winding, a printed noise cancelling coil (also known as the primary interface winding in this embodiment) on a secondary facing side of a double sided PCB, an auxiliary coil printed on a primary facing side of the same PCB and in series with the noise cancellation coil, plus a triple insulated secondary winding.

FIG. 8 is a typical electrical schematic diagram showing a transformer 43 according to Embodiment 2, with the auxiliary winding 44 split into two separate windings 46, 47 connected in series and jointed at a joint 42. The transformer further includes a primary winding 45 and a secondary winding 49. The split auxiliary winding 47 forms a primary interface winding and the secondary winding 49 forms a secondary interface winding.

FIGS. 9 to 13 show a typical construction of the transformer 43 of Embodiment 2. Depending on the choice of ferrites, which can be rectangular, circular or any other practical shapes, the insulator and winding shapes are accommodated accordingly to allow all parts to be aligned and assembled together properly to form a transformer.

FIGS. 9 to 13 show the transformer 43 using two rectangular shape ferrite halves 53 and 53′ each with a respective circular ferrite core center 62, 62′. The insulator shown in Embodiment 2 is a double-sided PCB 63 having two optional extended parts 54, 54′ at the bottom. The extended parts 54, 54′ are for connecting the primary winding 45 and the auxiliary winding 44 to the interface component, preferably to be the main board which is not shown in the drawings, of the power supply (not shown).

For practical reason, usually only part of the primary winding or the auxiliary winding would be used for noise cancellation purpose with the secondary winding. In Embodiment 2, part of the auxiliary winding 44 is used for this purpose. The auxiliary winding 44 is split into two series windings 46, 47 jointed together at the joint 42, as shown in FIG. 8.

The auxiliary winding 44 has one series winding 46 printed, usually in the form of spiral shape, on one side of the PCB 63 and the other series winding 47 printed, also usually in the form of spiral shape, on the other side of the PCB 63. For printing material, copper is preferably to be used for printed circuit board, while other conductive paintings or materials or conductive carbon materials or the like may also be considered. The two series windings 46, 47 are joined together by electrically connecting two pads 48, 48′ to form the joint 42. A winding end 57 of the auxiliary series winding 46 is located at an extended part 54 of the PCB 63 for external interface connection purpose. Another winding end 56 of the auxiliary series winding 47 is located on another side of the extended part 54 of PCB 63 for external interface connection purpose.

The primary winding 45, which is usually wound with safety approved enamel wire, is preferably wound in spiral shape in a construction having one or more layers. The primary winding 45 is attached to the side of the PCB 63 having the series auxiliary winding 46. One winding end 60 of the primary winding 45 is electrically connected to an electrical conductive printing pad 58′ on the PCB 63, whereas another winding end 60′ of the primary winding 45 is electrically connected to an electrical conductive printing pad 59′ on the PCB 63. The electrical conductive printing pads 58′, 59′ are further extended to another respective electrical conductive printing pad 58, 59 located at the extended PCB part 54′ for external electrical interface connection purpose.

The secondary winding 49, which is usually wound with safety approved triple insulation wire for safety insulation purpose, is preferably wound in spiral shape having one layer only but can be multi-layer if necessary, depending on whether the secondary interface winding is just part of or the whole of the secondary winding. The secondary interface winding of the secondary winding 49 is attached as close as possible to the side of the PCB 63 having the auxiliary series winding 47. The winding ends 55 and 55′ are preferably extended freely and terminate directly to the electrical interface component (not shown) of the power supply board (not shown).

For best noise cancellation performance, the number of turns and shape of the series auxiliary winding 47 (also known as the primary interface winding in this embodiment) together with the secondary interface winding of the secondary winding 49 are preferably to be designed and assembled such that the interface voltage swing or noise between the two windings is below a predefined desirable level.

In brief the construction of a transformer according to Embodiment 2 is the PCB 53 sandwiched between two ferrite halves 53, 53′. There is a noise cancellation or noise reduction purpose auxiliary series winding 47 (which is the primary interface winding in this embodiment) printed on the PCB 63 with a, preferably noise voltage swing sufficiently balanced, secondary interface winding of the secondary winding 49 properly positioned and closely attached to it. On the other side of the PCB 63 is printed another series auxiliary series winding 46, and with a primary winding 45 attached to it. All the parts are fixed together by proper adhesive or fixing materials (not shown) during the manufacturing process.

### Embodiment 3

A transformer according to Embodiment 3 is mainly a combination of Embodiment 1 and Embodiment 2, in which the secondary winding is sandwiched by two printed circuit boards and two primary windings. Further elaboration of similar embodiments to include multiple primary windings, multiple auxiliary windings and multiple secondary windings sandwiched together in a similar pattern are possible if the design so requires.

FIG. 14 is a typical electrical schematic diagram showing a transformer 70 according to Embodiment 3, with one auxiliary winding 74 split into two separate windings 75, 76 connected in series configuration jointed together at a joint 77. There are another auxiliary winding 78, two primary windings 72 and 73 and one secondary winding 71 in the transformer 70.

FIGS. 15 to 23 show a typical construction of the transformer 70. Depending on the choice of ferrites, which can be rectangular, circular or any other practical shapes the insulator and winding shapes are accommodated accordingly to allow all parts to be aligned and assembled together properly to form a transformer.

FIGS. 15 to 23 show the transformer 70 using two rectangular shape ferrite halves 80, 80′ each with a respective circular ferrite core center 101, 101′. The two insulators shown in this embodiment are printed circuit boards (PCBs). One PCB 89 is a singled sided board having an optional extended part 90 and the auxiliary winding 78 printed on one side of the board. The extended part 90 is for connecting the primary winding 73 and the auxiliary winding 78 to the interface component, preferably to be the main power supply board which is not shown in the drawings, of the power supply board (not shown).

FIGS. 20 and 21 show another PCB 81 having an optional extended part 85 with the series auxiliary winding 75 printed on one side and the other series auxiliary winding 76 printed on the other side of the PCB 81.

For practical reason, usually only part of the primary winding or the auxiliary winding would be used for noise cancellation or noise reduction purpose with the secondary winding. In Embodiment 3, the auxiliary winding 78 and part of the auxiliary winding 74 are used for this purpose. The auxiliary winding 74 is split into two series windings 75, 76 joined together at the joint 77, as shown in FIG. 14.

The auxiliary winding 74 has one series winding 75 formed (e.g. by printing), usually in the form of spiral shape, on one side of the PCB 81 and the other series winding 76 is formed (e.g. by printing), also usually in the form of spiral shape, on the other side of the PCB 81. For printing material, copper is preferably to be used for printed circuit board. The two series windings 75, 76 are joined together by electrically connecting the pads 88′, 100′ to form the joint 77. A winding end 100 of the auxiliary series winding 76 is located at the extended part 85 of the PCB 81 for external interface connection purpose. Another winding end 88 of the auxiliary series winding 75 is located on the other side of the extended part 85 of PCB 81 for external interface connection purpose.

The primary winding 72, which is usually wound with safety approved enamel wire, is preferably wound in spiral shape in a one-layer or multi-layer construction. The primary winding 72 is attached to the side of the PCB 81 having the series auxiliary winding 75. One winding end 84 of the primary winding 72 is electrically connected to an electrical conductive printing pad 86′ on the PCB 81, and the another winding end 83 of the primary winding 72 is electrically connected to an electrical conductive printing pad 87′ on the PCB 81. The electrical conductive printing pads 86′, 87′ are further extended to another respective electrical conductive printing pad 86, 87 located at the extended PCB part 85 for external electrical interface connection purpose. Sufficient functional clearance between the connection pads and the windings is required for reliability purpose.

Another auxiliary winding 78 is formed (e.g. by printing), usually in spiral shape, by using a conductive material, which is usually copper for printed circuit board, on one side of the PCB 89. One winding end 96 of the auxiliary winding 78 is located at the optional extended PCB part 90 for external interface connection purpose. Another winding end 96′ of the auxiliary winding 78 is located at the inner spiral. The winding end 96′ is electrically connected to an electrical connection point 92′ via an electrical conductor 103 located on the side of the PCB 89 opposite to the side having the auxiliary winding 78. The conductor 103 may be an electrical wire as shown in the drawings if the PCB 89 is single-sided. It may be a printed trace (not shown) if the PCB 89 is double sided. Another end 92 of the electrical conductor 103 is electrically connected to an electrical conductive printing pad 98′ on the PCB 89. The electrical connection of the electrical conductive printing pad 98′ is further extended to another electrical conductive printing pad 98 located at the extended PCB part 90 for external electrical interface connection purpose.

The other primary winding 73, which is usually wound with safety approved enamel wire, is preferably wound in spiral shape having a one-layer or multi-layer construction. The primary winding 73 is attached to the side of the PCB 89 opposite to the auxiliary winding 78. One winding end 91 of the primary winding 73 is electrically connected to an electrical conductive printing pad 97′ on the PCB 89, and another winding end 93 of the primary winding 73 is electrically connected to an electrical conductive printing pad 99′ on the PCB 89. The electrical conductive printing pads 97′, 99′ are further extended to another respective electrical conductive printing pad 97, 99 located at the extended PCB part 90 for external electrical interface connection purpose.

The secondary winding 71, which is usually wound by safety approved triple insulation wire for safety insulation purpose, is preferably wound in spiral shape having one layer only but can be multi-layer if necessary, depending on whether the secondary interface winding is a part or the whole of the secondary winding. The secondary winding 71 is attached as close as possible to the side of the PCB 81 having the auxiliary series winding 76 and also the side of the PCB 89 having the auxiliary winding 78. The winding ends 82, 82′ are preferably extended freely and terminate directly to the electrical interface component (not shown) of the power supply board (not shown).

For best noise cancellation performance, the number of turns and shape of the auxiliary winding 78, the series auxiliary winding 76 (which collectively form the primary interface winding) together with the secondary winding 71 (which is also the secondary interface winding in this embodiment if it is a one-layer winding construction) are preferably to be designed and assembled such that the interface voltage swing between the two windings is below a predefined desirable level.

In brief the construction of a transformer according to Embodiment 3 is the secondary winding 71 sandwiched by two ferrite halves 80, 80′, and by two primary windings 72, 73. One PCB 89 is placed between the secondary winding 71 and the primary winding 73; and the primary winding 73 and the PCB 89 are bonded together to form a primary winding assembly 95, and another PCB 81 is placed between the secondary winding 71 and the primary winding 72. All the parts are fixed together by proper adhesive or fixing materials (not shown) during the manufacturing process.

### Embodiment 4

This is mainly an enhancement of Embodiment 1 in which the primary winding is sandwiched by two printed circuit boards and two secondary windings. With this configuration the coupling between the primary interface winding and the secondary interface winding can be improved.

FIG. 53 is a typical electrical schematic diagram showing a transformer 210 according to Embodiment 4, with one primary winding 211, two auxiliary windings 212, 213, and two secondary windings 214, 215. The auxiliary windings 212, 213 collectively form a primary interface winding and the secondary windings 214, 215 collectively form a secondary interface winding.

FIGS. 54 to 60 show a typical construction of the transformer 210 according to Embodiment 4. Depending on the choice of ferrites, which can be rectangular, circular or any other practical shapes, the insulator and winding shapes are accommodated accordingly to allow all parts to be aligned and assembled together properly to form a transformer.

FIGS. 54 to 60 show the transformer 210 having two rectangular shape ferrite halves 221, 221′ each with a respective circular ferrite core center 251, 251′. The two insulators shown in this embodiment are printed circuit boards (PCBs). One PCB 230 is a double-sided board having a main PCB part 231, a hole 232, an optional extended part 222 and an auxiliary winding 212 printed on one side of the PCB 230. One end of the auxiliary winding 212 terminates at a termination 225′, and the other end terminates at a termination 225. The termination 225 is electrically connected to a termination 236 on an opposite side of the PCB 230 via an electrical conductor (usually a plated through hole) connected between 237 and 238. The termination 236 is further extended to 236′ at the extended PCB part 222. The side of the PCB 230 opposite to the auxiliary winding side may have an optional shield pattern 233. One connection point 234 is electrically connected to the shield pattern 233, and is electrically extended to a connection point 234′ located at the extended PCB part 222. The extended part 222 is for connecting one end of the primary winding 211 and the auxiliary winding 212 to the interface component, preferably to be the main power supply board which is not shown in the drawings, of the power supply board (not shown).

Another PCB 230′ is of a similar construction as the PCB 230, with another auxiliary winding 213 printed on it.

The primary winding 211 is usually wound with safety approved enamel wire. One end 224 of the primary winding 211 is electrically connected to the connection point 234 of the PCB 230 to form the primary-PCB-assembly 240. The gap between the primary winding 211 and the PCB 230 should be as small as possible. Another end 224′ of the primary winding 211 is preferably extended freely and terminates directly to the electrical interface component (not shown) of the power supply board (not shown).

For best noise cancellation or noise reduction performance, the number of turns and shape of the auxiliary windings 212/213 (which collectively form two primary interface windings in this embodiment) together with the secondary windings 214/215 (which collectively form two secondary interface windings in this embodiment) are preferably designed and assembled such that the interface voltage swing or noise between them is below a predefined desirable level.

The secondary windings 214, 215, which are usually wound by safety approved triple insulation wire for safety insulation purpose, are preferably wound in spiral shape having one layer only but may be multi-layer if necessary, depending on whether the secondary interface winding is a part of or the whole of the secondary winding. The secondary winding 214 is attached as close as possible to the side of the PCB 230 having the auxiliary winding 212. The secondary winding 215 is attached as close as possible to the side of the PCB 230′ having the auxiliary winding 213. The winding ends 223, 223′, 228, 228′ are preferably extended freely and terminate directly to the electrical interface component (not shown) of the power supply board (not shown).

In brief the construction of the Embodiment 4 is the primary winding 211 sandwiched by two ferrite halves 221, 221′, and by two secondary windings 214, 215, and by two shielding PCBs 230, 230′. All the parts are fixed together by proper adhesive or fixing materials (not shown) during the manufacturing process.

### Embodiment 5

This embodiment comprises a bobbinless secondary winding wound with triple insulated wire, a printed noise cancelling coil on a secondary facing side of a coil holding device, one bobbinless auxiliary coil winding for electrical conduction purpose on a primary facing side of the coil holding device and followed by a bobbinless primary winding.

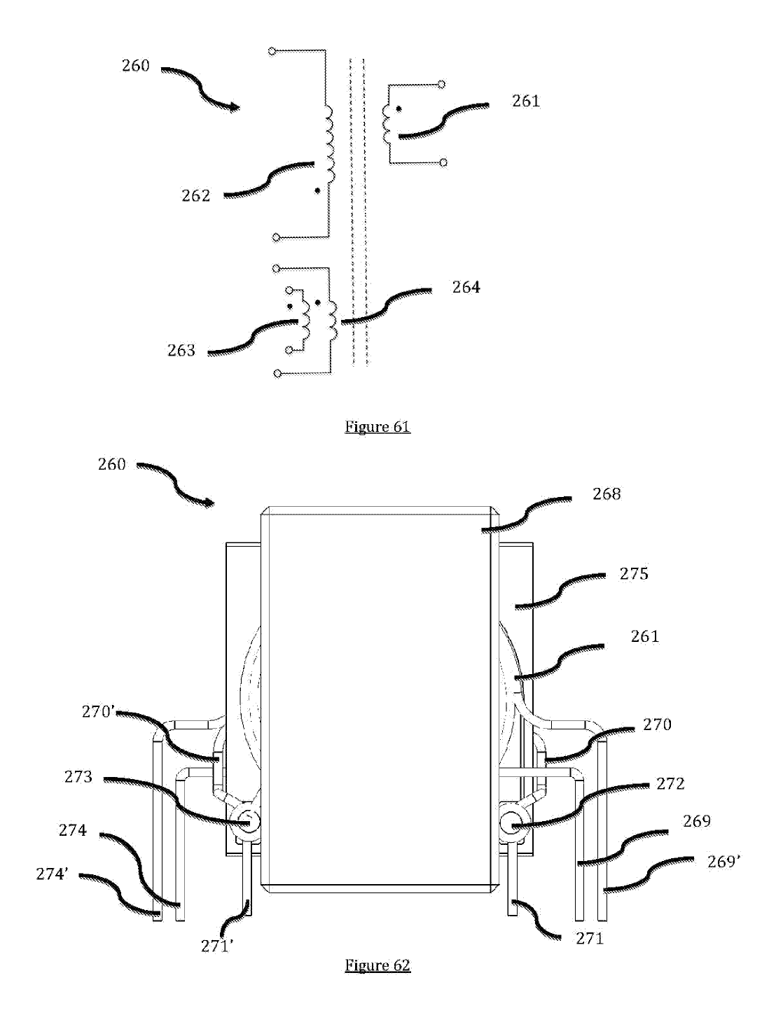

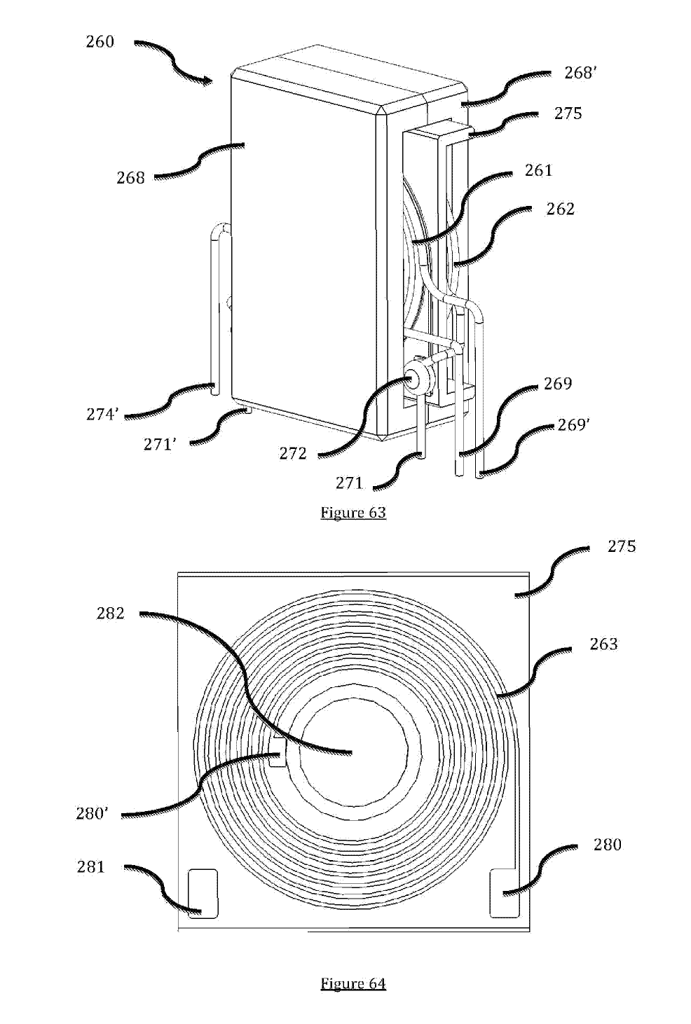

FIG. 61 is a typical electrical schematic diagram showing a transformer 260 according to Embodiment 5, with two auxiliary windings 263, 264, a primary winding 206 and a secondary winding 261.

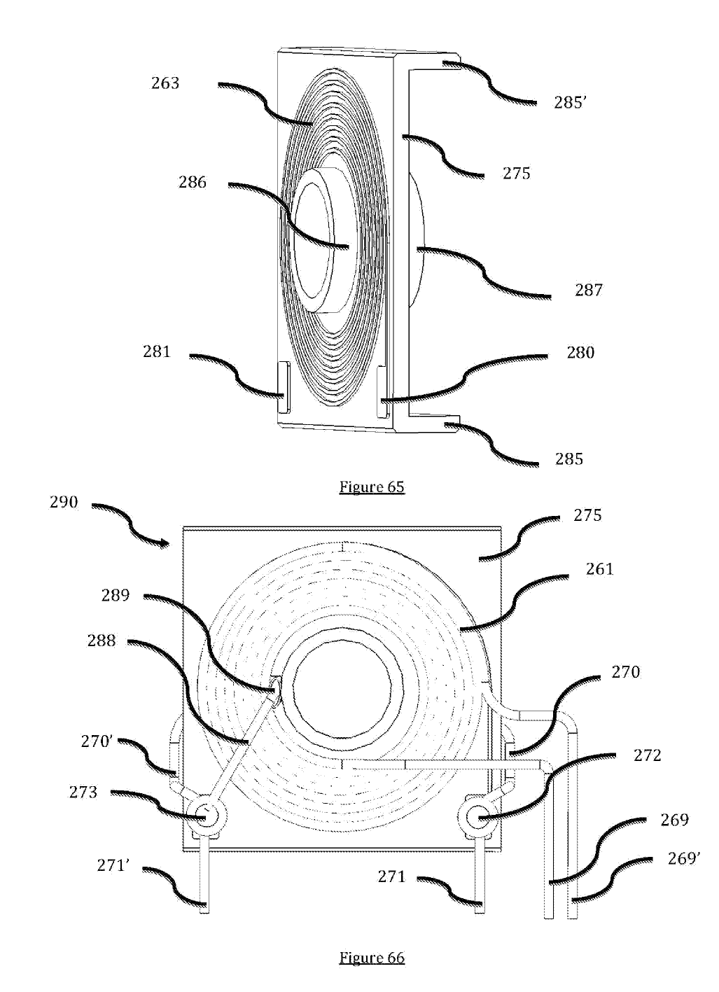

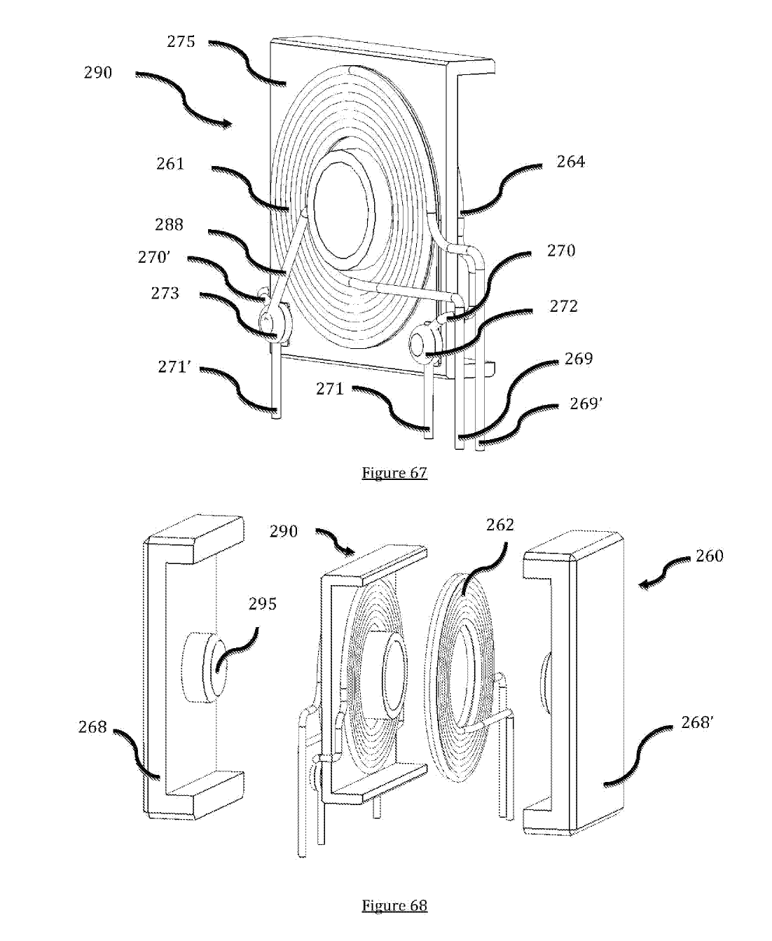

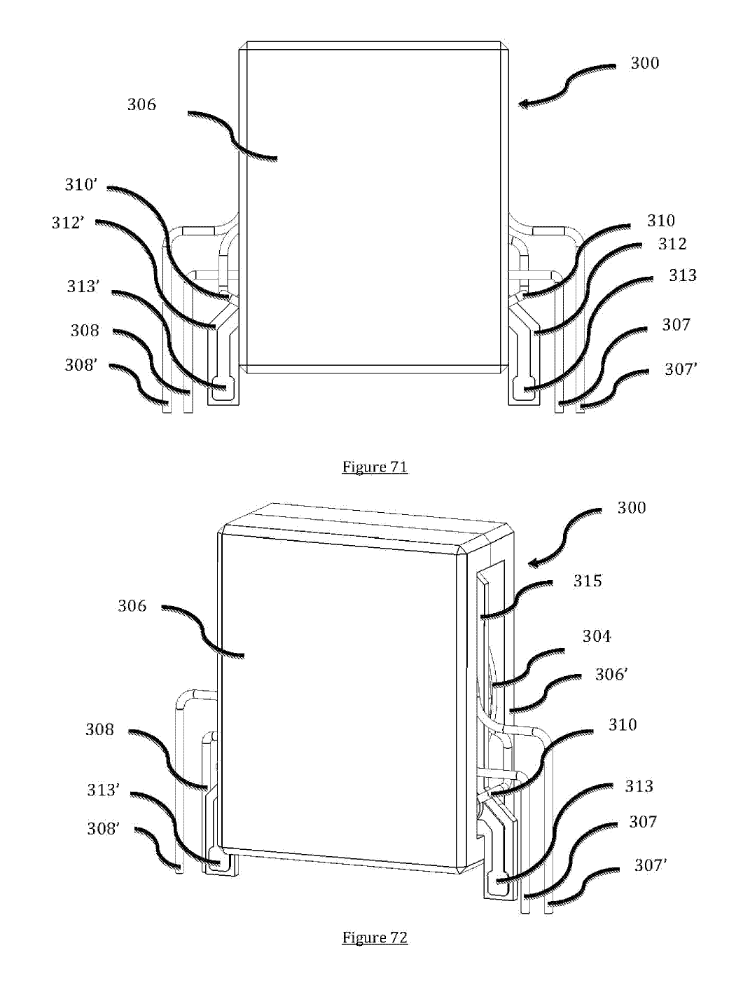

FIGS. 62 to 69 show a typical construction of the transformer 260 of Embodiment 5. Depending on the choice of ferrites, which can be rectangular, circular or any other practical shapes, the insulator and winding shapes are accommodated accordingly to allow all parts to be aligned and assembled together properly to form a transformer.

FIGS. 62 to 69 show the transformer 260 including two rectangular shape ferrite halves 268, 268′ each with a respective circular ferrite core center 295, 295′. A coil holding device 275 shown in this embodiment is an insulation device having two optional flanges 285, 285′ on the top and the bottom respectively, and two optional protruded circular rings 286, 287 with a hole 282 in roughly the center. The shielding auxiliary winding 263 is formed, e.g. by etching, engraving or printing (usually in the form of spiral shape) with conductive material or carbon conductive painting or the like on the secondary facing side of the coil holding device 275. An outer end of the auxiliary winding 263 is terminated to a pad 280 for interface connection purpose, and an inner end of the auxiliary winding 263 is connected to a pad 280′. Another pad 281 is printed on the coil holding device 275 for interface connection purpose.

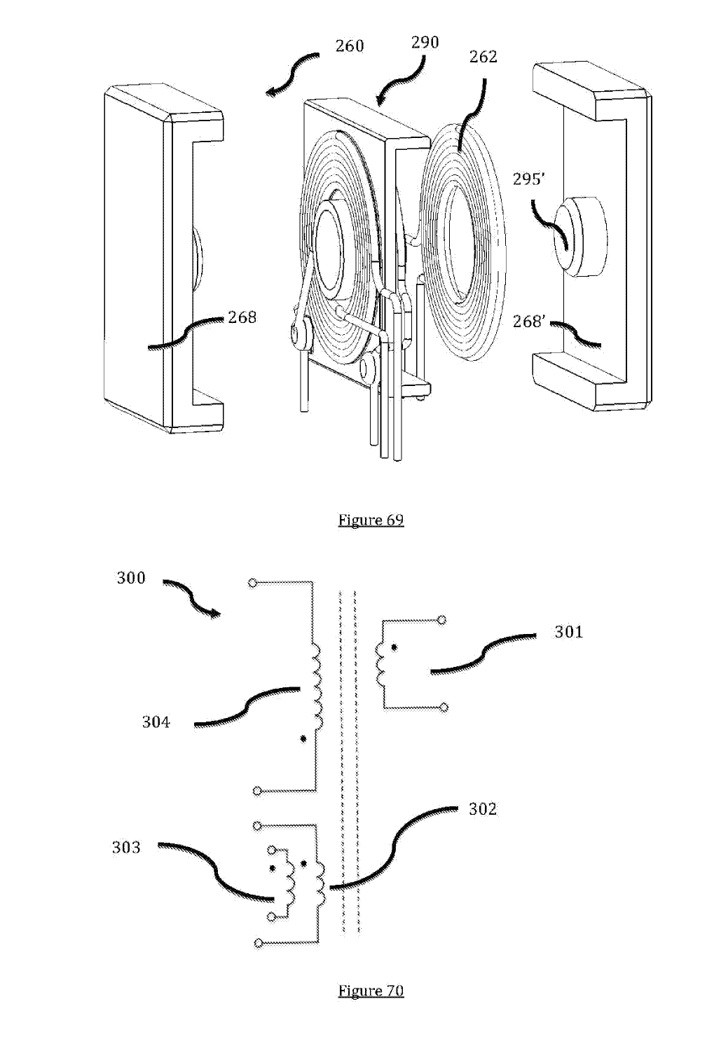

FIGS. 66 and 67 show a partial winding assembly 290 of the coil holding device 275 together with the secondary winding 261 (which is also the secondary interface winding in this particular embodiment as it is the whole of the secondary winding 261, whereas it could be just a part of the secondary winding 261 in other variations of this embodiment if the secondary winding 261 has more than more layer) and the other auxiliary winding 264. The secondary winding 261, which is usually wound with triple insulated wire, is placed closely to the surface of the coil holding device 275 with the side on which the auxiliary winding 263 (also known as the primary interface winding in this embodiment) is printed. A jumper wire 288 is connected between connection points 280′ and 281 for external electrical connection interface purpose. The connection points 280, 281 are further extended respectively by connecting jumper wires 271, 271′. The other auxiliary winding 264 (for compensating the higher resistance due to potentially higher resistive of the carbon printed auxiliary winding 263) is placed on an opposite side of the coil holding device 275. The wire terminations 270, 270′ of the auxiliary winding 264 are folded to terminate at connection points 280, 281 respectively. Connection points 280, 281 are further extended for external electrical interface connection by connecting jumper wires 271, 271′ respectively. All electrical connections are joined together by solder or adding conductive glue or the like.

In brief the construction of Embodiment 5 is that the primary winding 262 and the partial winding assembly 290 are sandwiched between two ferrite halves 268, 268′. A noise cancellation purpose auxiliary winding 263 is printed on the coil holding device 275 with a, preferably noise voltage swing sufficiently balanced, secondary winding 261 properly positioned and closely attached to it. All the parts are fixed together by proper adhesive or fixing materials (not shown) during the manufacturing process.

### Embodiment 6

This is another embodiment comprising a bobbinless secondary winding wound with triple insulated wire, a printed noise cancelling coil on a secondary facing side of a PCB, one bobbinless auxiliary coil winding for electrical conduction purpose on a primary facing side of the PCB and followed by the bobbinless primary winding.

FIG. 70 is a typical electrical schematic diagram showing a transformer 300 according to Embodiment 6, with two auxiliary windings 302, 303, a primary winding 304 and a secondary winding 301.

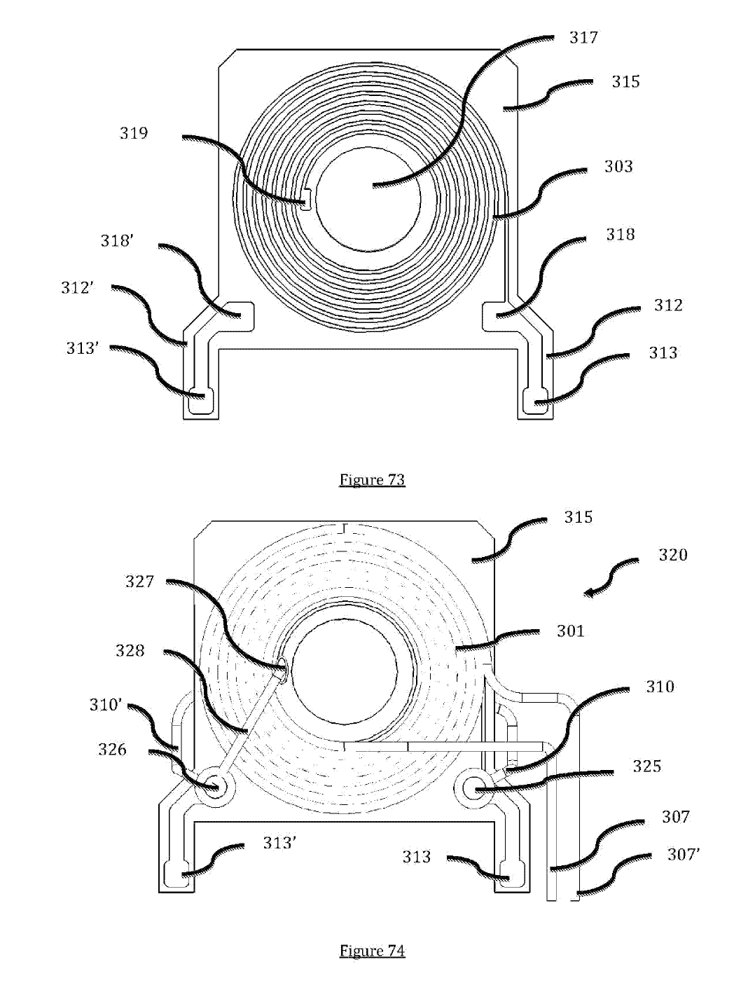

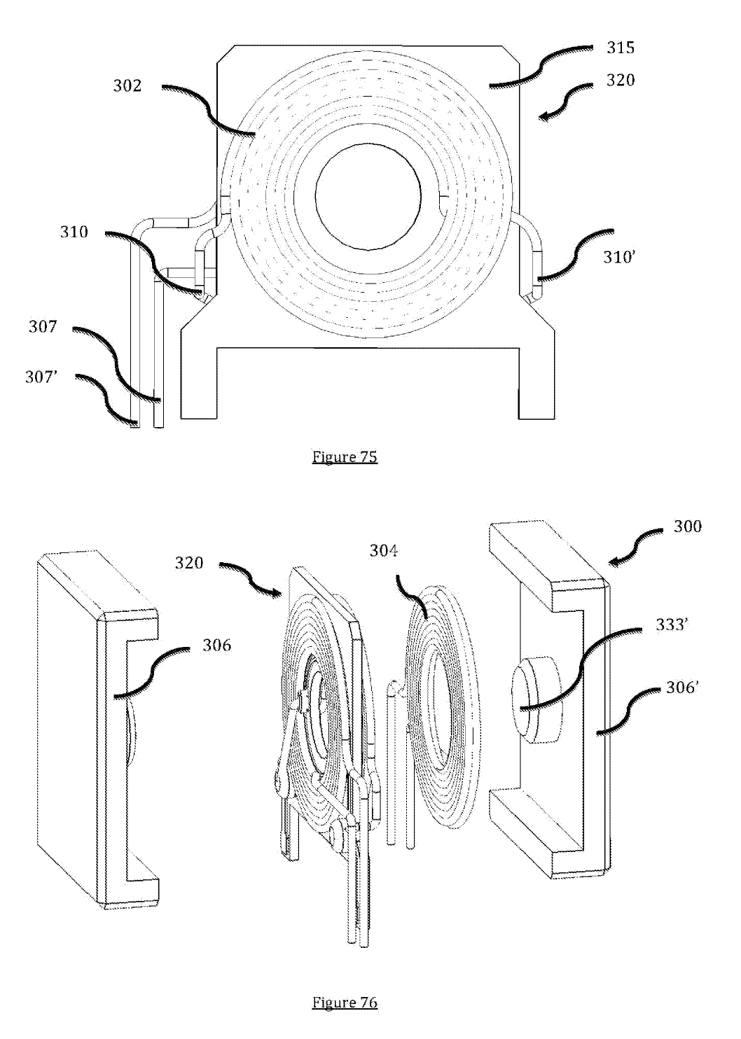

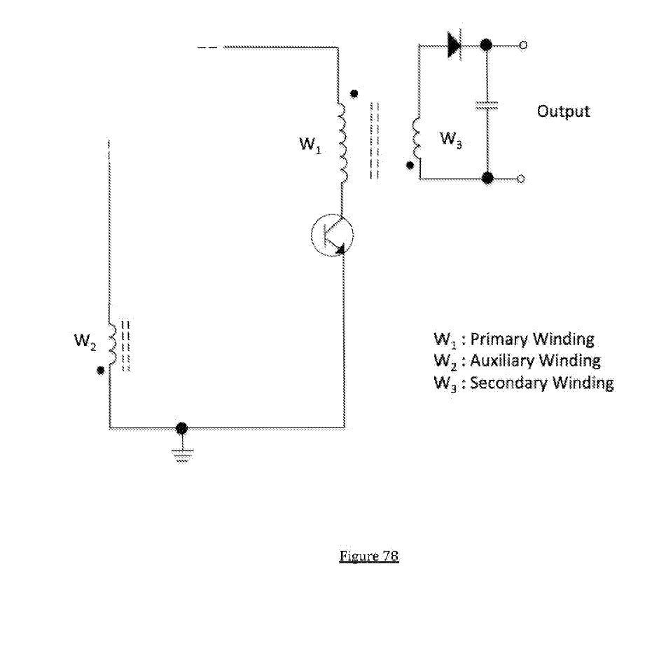

FIGS. 71 to 77 show a typical construction of the transformer 300 of this embodiment. Depending on the choice of ferrites, which can be rectangular, circular or any other practical shapes, the insulator and winding shapes are accommodated accordingly to allow all parts to be aligned and assembled together properly to form a transformer.

FIGS. 71 to 77 show the transformer 300 including two rectangular shape ferrite halves 306, 306′, each with a respective circular ferrite core center 333, 333′. A PCB 315 of this embodiment is an insulation device having two optional flanges 312, 312′ with a hole 317 in roughly the center. A shielding auxiliary winding 303 is formed, e.g. by etching, engraving or printing (usually in the form of spiral shape) with conductive material or carbon conductive painting or the like on the secondary facing side of the PCB 315. An outer end of the auxiliary winding 303 is terminated to a pad 313 for interface connection purpose, and an inner end of the auxiliary winding 303 is connected to a pad 319. Another pad 313′ is printed on the PCB 315 for interface connection purpose.

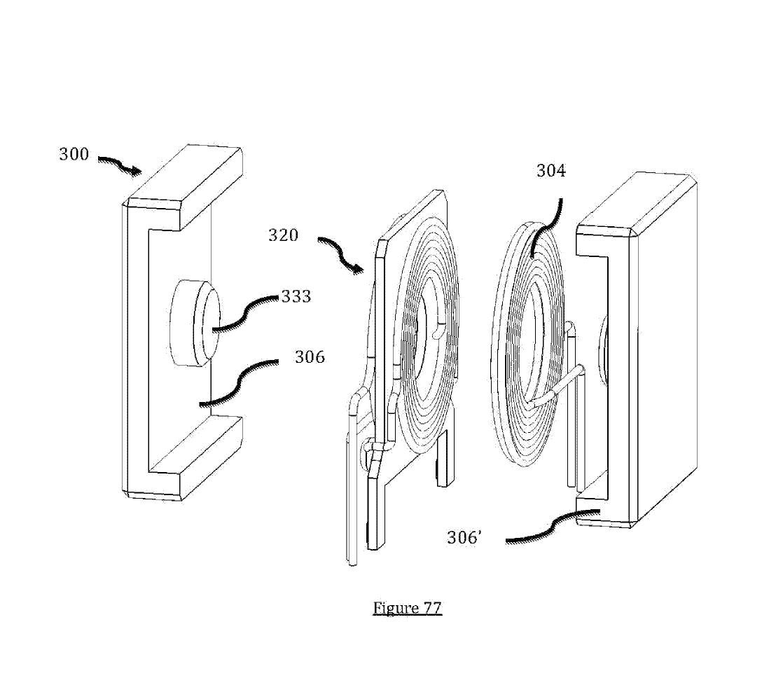

FIGS. 74 and 75 show a partial winding assembly 320 of the PCB 315 together with the secondary winding 301 (which is also the secondary interface winding in this particular embodiment as it is the whole of the secondary winding 301, whereas it could be just a part of the secondary winding 301 in other variations of this embodiment if the secondary winding 301 has more than one layer) and the other auxiliary winding 302. The secondary winding 301, which is usually wound with triple insulated wire, is placed closely to the surface of the PCB 315 with the side on which the auxiliary winding 303 (also known as primary interface winding in this embodiment) is printed. A jumper wire 328 is connected between connection points 318′ and 319 for external electrical connection interface purpose. The connection points 318, 318′ are respectively further extended to 313, 313′ for external electrical interface purpose. The other auxiliary winding 302 (for compensating the higher resistance due to potentially higher resistive of the carbon printing auxiliary winding 303) is placed on an opposite side of the PCB 315. Wire terminations 310, 310′ of the auxiliary winding 302 are folded to terminate at connection points 318, 318′ respectively. All electrical connections are joined together by solder or adding conductive glue or the like.

In brief the construction of the Embodiment 6 is the primary winding 304 and the partial winding assembly 320 sandwiched between two ferrite halves 306, 306′. A noise cancellation purpose auxiliary winding 303 is printed on the PCB 315 with a, preferably noise voltage swing sufficiently balanced, secondary winding 301 properly positioned and closely attached to it. All the parts are fixed together by proper adhesive or fixing materials (not shown) during the manufacturing process.

For the second construction with the coil windings molded by plastic encapsulation, it is realized by Embodiments 7 and 8 described below as typical examples. The secondary interface winding may be a part or the whole of the secondary winding. If the secondary winding has a plural number of winding layers, then the secondary interface winding is the part of the secondary winding directly facing the primary auxiliary winding. For the purpose of easier illustration of these embodiments, unless otherwise specified, the secondary interface winding is simply assumed to be the whole of the secondary winding, as the drawings show that the secondary winding would have one single layer of winding construction. Because of this assumption, the term “secondary winding” and “secondary interface winding” may be used interchangeably when used in relation to these embodiments. It is important to note that, in practice, the whole secondary winding may have a plural number of conductors and a plural number of winding layers.

### Embodiment 7

This is the simplest form of the second construction comprising an overmolded pancake or spiral shape secondary winding, a noise cancellation coil winding printed on the overmold facing the primary winding, and lastly a bobbinless primary winding.

FIG. 24 is a typical electrical schematic diagram showing a transformer 110 according to Embodiment 7, with a primary winding 111, an auxiliary winding 112 (as also known primary interface winding in this embodiment), and a secondary winding 113.

FIGS. 25 to 32 show a typical construction of transformer 110 of this embodiment. Depending on the choice of ferrites, which can be rectangular, circular or any other practical shapes, the overmold and winding shapes are accommodated accordingly to allow all parts to be aligned and assembled together properly to form a transformer.

FIGS. 25 to 32 show the transformer 110 including two rectangular shape ferrite halves 114, 114′ each with a respective circular ferrite core center 135, 135′.

The secondary winding 113, which is usually wound with safety approved enamel wire, is preferably wound in pancake or spiral shape having one layer only but can be multi-layer if necessary, depending on whether the secondary interface winding is a part of or the whole of the secondary winding 113. The pancake secondary winding 113 is overmolded by encapsulation, or plastic, or resin, or other suitable material for the purpose of safety isolation. The secondary winding 113 is placed as close as possible to the side on which the primary interface winding is printed for best noise reduction purpose, while maintaining safety insulation requirement. The overmolded secondary winding 122 has an optional extended part 115 to maintain minimum safety distances between the terminating wires 116, 116′ and the other primary side components of the transformer 110. Winding ends 116, 116′ are preferably extended freely and terminate directly to the electrical interface component (not shown) of the power supply board (not shown).

The overmolded secondary winding 122 has another optional extended part 117 for connecting the primary winding 111 and the auxiliary winding 112 to the interface component, preferably to be the main board which is not shown in the drawings, of the power supply board (not shown).

The auxiliary winding 112 that forms the shield winding is printed, usually in spiral shape, by using conductive material, on the side of the overmolded secondary 122 that is nearest to the secondary interface winding of the secondary winding 113. One winding end 118 of the auxiliary printed winding 112 is located at the extended overmold part 117 for external interface connection purpose. Another winding end 118′ of the auxiliary printed winding 112 is located at the inner spiral. The winding end 118′ is electrically connected to an electrical connection point 120′ via a connection point 133′ of an electrical conductor 131. Another end 133 of the electrical conductor 131 is electrically connected to the connection pad 120′ on the overmolded secondary winding 122. The electrical connection of the electrical connection pad 120′ is further extended to another electrical conductive printing pad 120 located at the extended overmolded part 117 for external electrical interface connection purpose.

The primary winding 111, which is usually wound with safety approved enamel wire, is preferably wound in spiral shape having a one-layer or multi-layer construction. The primary winding 111 is attached to the side of the overmolded secondary winding 122 having the auxiliary printed winding 112. One winding end 132 of the primary winding 111 is electrically connected to the electrical conductive printing pad 119′ on the overmolded secondary winding 122, and another winding end 132′ of the primary winding 111 is electrically connected to an electrical conductive printing pad 121′ on the overmolded secondary 122 winding. The electrical conductive printing pads 119′, 121′ are each further extended respectively to another electrical conductive printing pad 119, 121 located at the extended overmolded part 117 for external electrical interface connection purpose. This whole assembly forms a complete overmolded winding assembly 130.

For best noise cancellation or noise reduction performance, the number of turns and shape of the auxiliary winding 112 (also known as the primary interface winding in this embodiment) together with the secondary winding 113 (also the secondary interface winding of the secondary winding 113 if the secondary winding 113 has a plural number of winding layers) are preferably designed and assembled such that the interface voltage swing between the two windings is below a predefined desirable level.

In brief the construction of the Embodiment 7 is the overmolded winding assembly 130 sandwiched between the two ferrite halves 114, 114′. All the parts are fixed together by proper adhesive or fixing materials (not shown) during the manufacturing process.

### Embodiment 8

This is a sandwiched overmold secondary winding construction comprising an overmolded pancake or spiral shape secondary winding, one noise cancellation coil winding printed on each side of the overmold, and one bobbinless primary winding attached to each side of it.

FIG. 33 is a typical electrical schematic diagram showing a transformer 140 according to Embodiment 8, with two primary windings 141, 148, two auxiliary windings 143, 144, and one secondary winding 142.

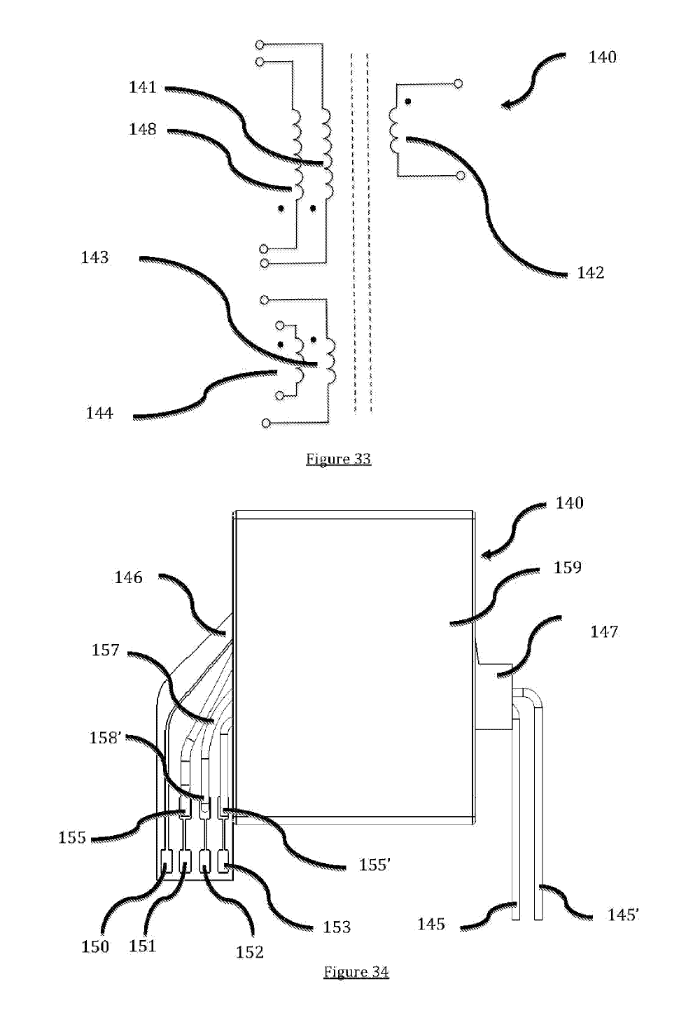

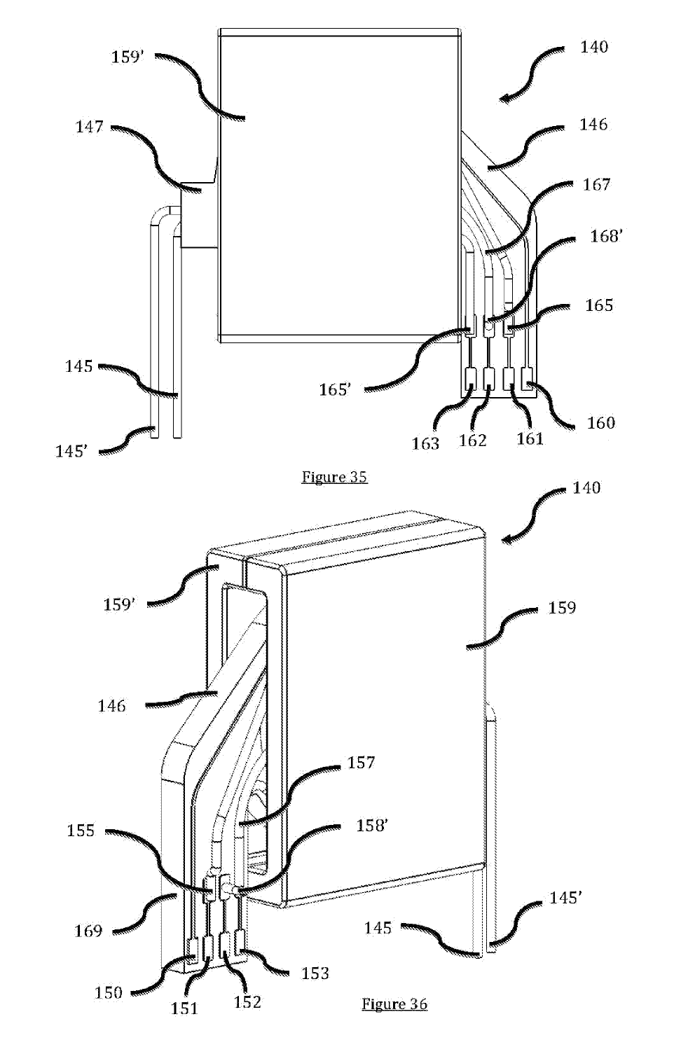

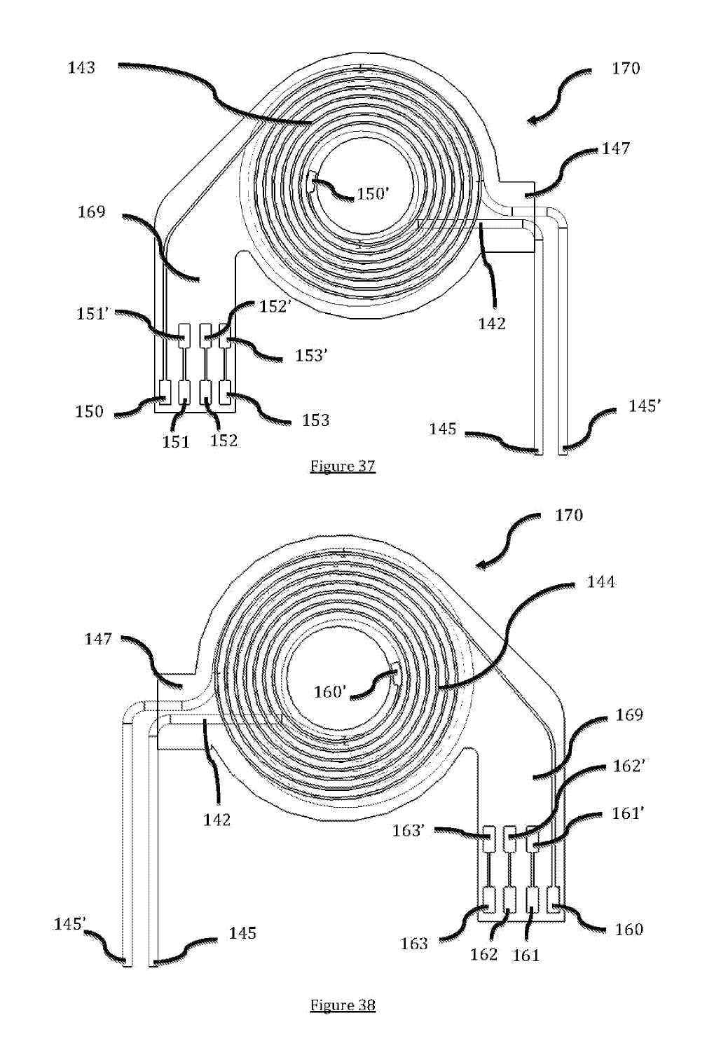

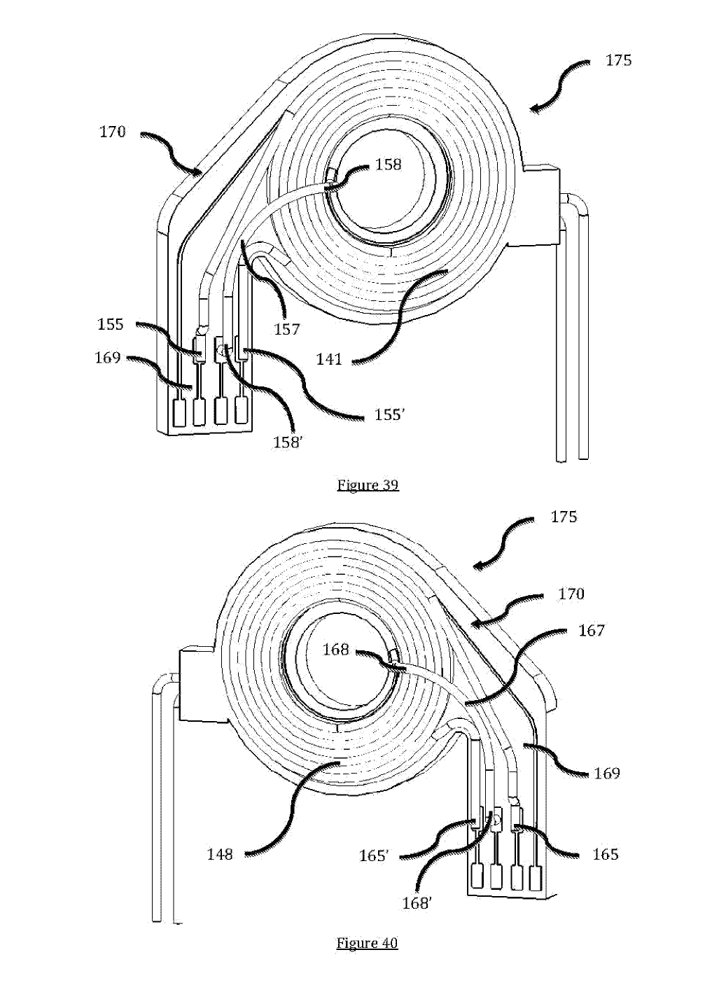

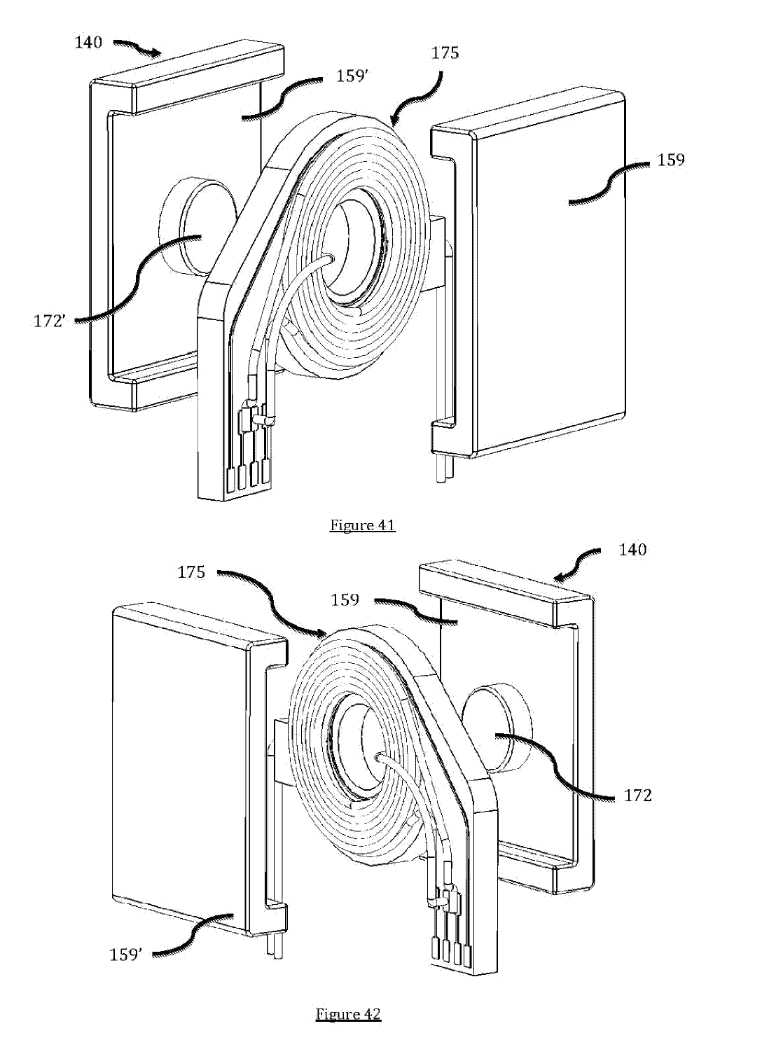

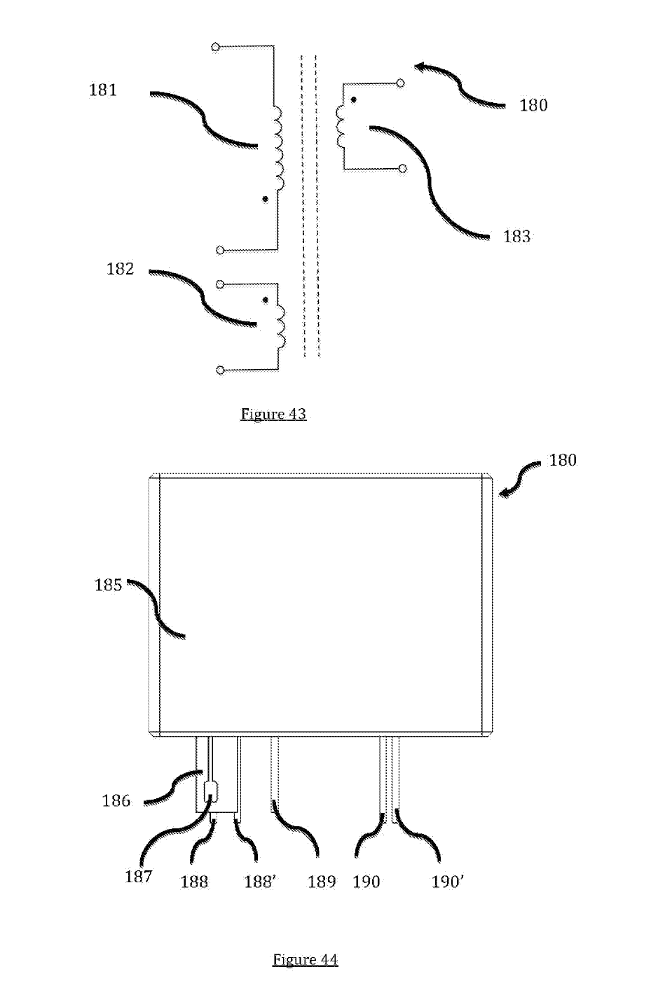

FIGS. 34 to 42 show a typical construction of transformer 140 of this embodiment. Depending on the choice of ferrites, which can be rectangular, circular or any other practical shapes, the overmold and winding shapes are accommodated accordingly to allow all parts to be aligned and assembled together properly to form a transformer.

FIGS. 34 to 42 show the transformer 140 having two rectangular shape ferrite halves 159, 159′ each with a respective circular ferrite core center 172, 172′.

The secondary winding 142, which is usually wound with safety approved enamel wire, is preferably wound in pancake or spiral shape having preferably one layer only in this particular embodiment to simplify the interface construction between the primary interface winding and the secondary interface winding. The pancake secondary winding 142 is overmolded by encapsulation, or plastic, or resin, or other suitable material for the purpose of safety isolation. The overmolded secondary winding 170 has an optional extended part 147 to maintain minimum safety distances between the terminating wires 145, 145′ and the other primary side components of the transformer 140. The winding ends 145, 145′ are preferably extended freely and terminate directly to the electrical interface component (not shown) of the power supply board (not shown).

The overmolded secondary winding 170 has another optional extended part 169 for connecting the two primary windings 141, 148 and the two auxiliary winding 143, 144 to the interface component, preferably to be the main board which is not shown in the drawings, of the power supply board (not shown).

The first auxiliary winding 143 that forms the shield winding is printed or etched, usually in spiral shape, by using conductive material, on one side of the overmolded secondary winding 170. One winding end 150 of the auxiliary printed winding 143 is located at the extended overmold part 169 for external interface connection purpose. Another winding end 150′ of the first auxiliary printed winding 143 is located at the inner spiral. The winding end 150′ is electrically connected to an electrical connection point 152′ via a connection point 158′ of an electrical conductor 157. Another end 158 of the electrical conductor 157 is electrically connected to the connection pad 150′ on the overmolded secondary winding 170. The electrical connection of the electrical connection pad 152′ is further extended to another electrical conductive printing pad 152 located at the extended overmolded part 169 for external electrical interface connection purpose.

The second auxiliary winding 144 that forms the shield winding is printed or etched, usually in spiral shape, by using conductive material, on one side of the overmolded secondary winding 170. One winding end 160 of the auxiliary printed winding 144 is located at the extended overmold part 169 for external interface connection purpose. Another winding end 160′ of the first auxiliary printed winding 144 is located at the inner spiral. The winding end 160′ is electrically connected to an electrical connection point 162′ via a connection point 168′ of an electrical conductor 167. Another end 168 of the electrical conductor 167 is electrically connected to the connection pad 160′ on the overmolded secondary winding 170. The electrical connection of the electrical connection pad 162′ is further extended to another electrical conductive printing pad 162 located at the extended overmolded part 169 for external electrical interface connection purpose.

The first primary winding 141, which is usually wound with safety approved enamel wire, is preferably wound in spiral shape having a one-layer or multi-layer construction. The primary winding 141 is attached to the side of the overmolded secondary winding 170 having the auxiliary printed winding 143. One winding end 155 of the primary winding 141 is electrically connected to the electrical conductive printing pad 151′ on the overmolded secondary winding 170, and another winding end 155′ of the primary winding 141 is electrically connected to the electrical conductive printing pad 153′ on the overmolded secondary winding 170. Each of the electrical conductive printing pads 151′, 153′ is further extended respectively to another electrical conductive printing pad 151, 153 located at the extended overmolded part 169 for external electrical interface connection purpose. The second primary winding 148, which is usually wound with safety approved enamel wire, is preferably wound in spiral shape having a one-layer or multi-layer construction. The primary winding 148 is attached to the side of the overmolded secondary winding 170 having the auxiliary printed winding 144. One winding end 165 of the primary winding 148 is electrically connected to an electrical conductive printing pad 161′ on the overmolded secondary winding 170, and another winding end 165′ of the primary winding 148 is electrically connected to an electrical conductive printing pad 163′ on the overmolded secondary winding 170. Each of the electrical conductive printing pads 161′, 163′ is further extended respectively to another electrical conductive printing pad 161, 163 located at the extended overmolded part 169 for external electrical interface connection purpose. This whole assembly forms the complete overmolded winding assembly 175.

For best noise cancellation or noise reduction performance, the number of turns and shape of the auxiliary winding 143, 144 (collectively forming the primary interface windings) together with the secondary winding 142 (also as the secondary interface winding) are preferably designed and assembled such that the interface voltage swing or noise between the windings is below a predefined desirable level.

In brief the construction of Embodiment 8 is the overmolded winding assembly 175 sandwiched between the two ferrite halves 159 and 159′. All the parts are fixed together by proper adhesive or fixing materials (not shown) during the manufacturing process.

For the third construction with the coil windings wound on a slotted bobbin, it is realized by Embodiment 9 described below as a typical example. The secondary interface winding may be a part or the whole of the secondary winding. If the secondary winding has a plural number of winding layers then the secondary interface winding is the part of the secondary winding directly facing the primary auxiliary winding. For the purpose of easier illustration of this embodiment, unless otherwise specified, the secondary interface winding is simply assumed to be the whole of the secondary winding, as the drawings show that the secondary winding has one single layer of winding construction. Because of this assumption, the terms “secondary winding” and “secondary interface winding” may be used interchangeably when used in relation to this embodiment. It is important to note that, in practice, the whole secondary winding may have a plural number of conductors and a plural number of winding layers.

### Embodiment 9

This embodiment comprises a single slotted bobbin wherein the primary winding is wound in the slot, and the noise cancellation winding is printed on the side of the bobbin facing the secondary winding would by triple insulated wire.

FIG. 43 is a typical electrical schematic diagram showing a transformer 180 of Embodiment 9, with a primary winding 181, an auxiliary winding 182, and a secondary winding 183.

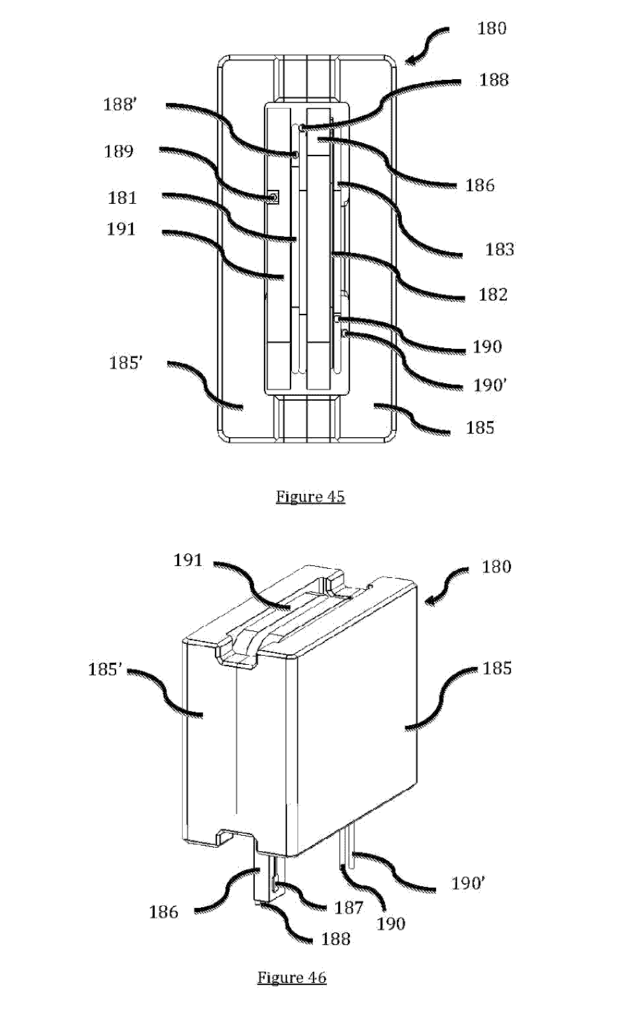

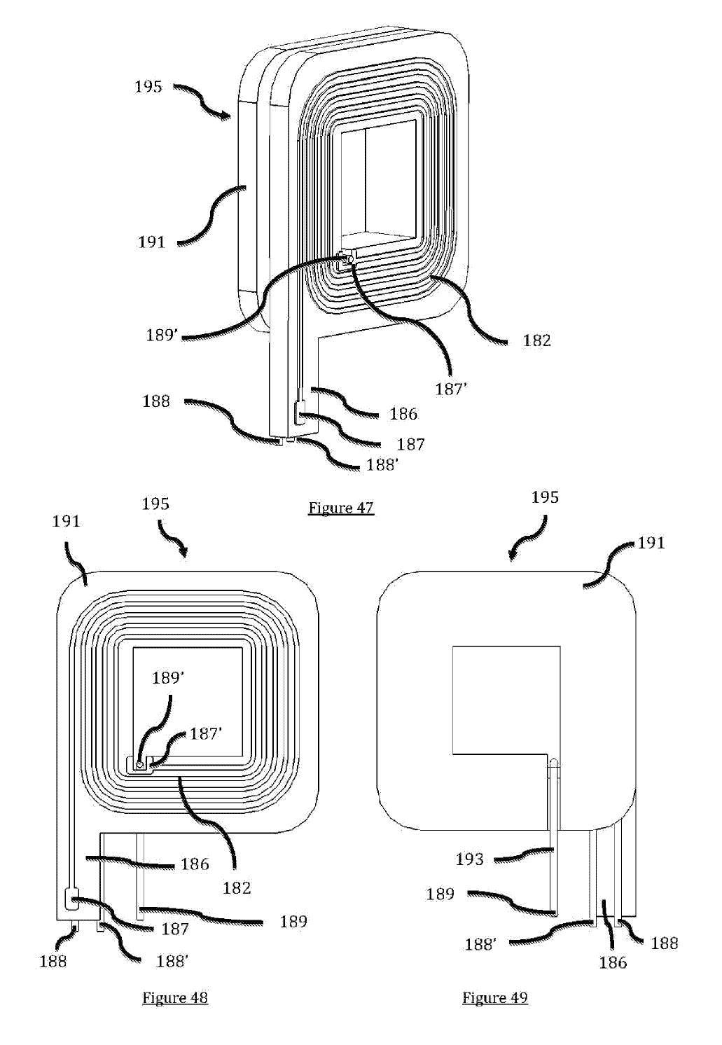

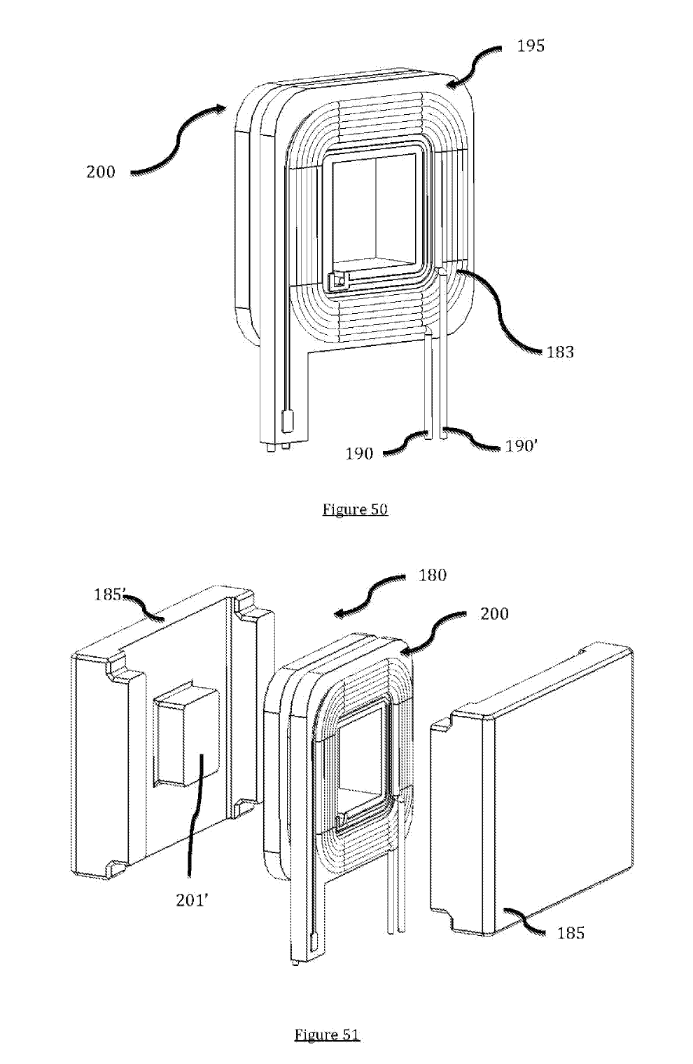

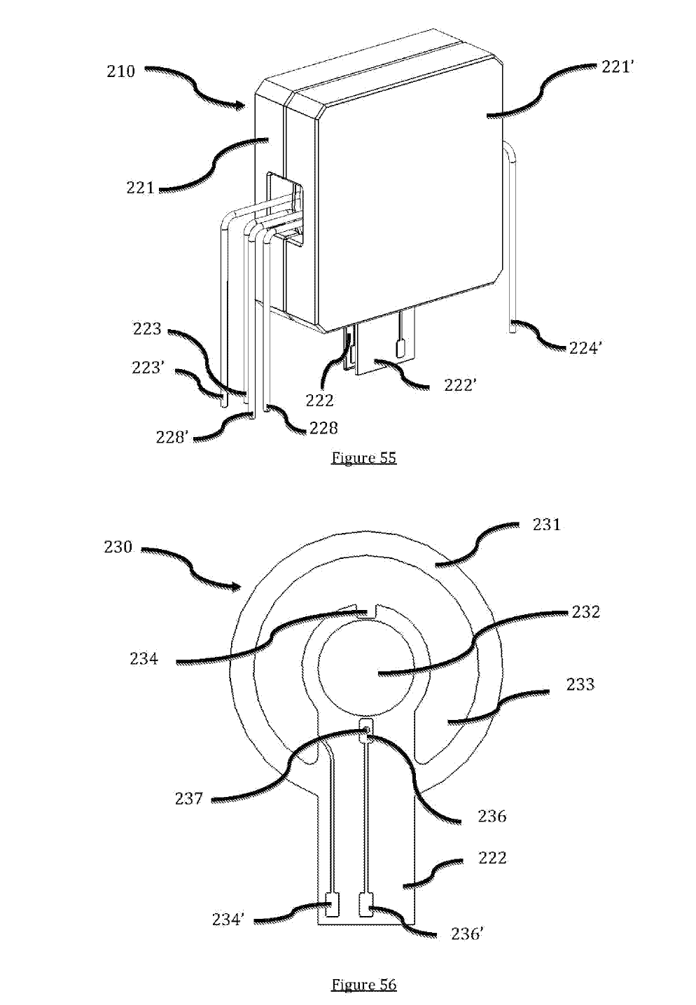

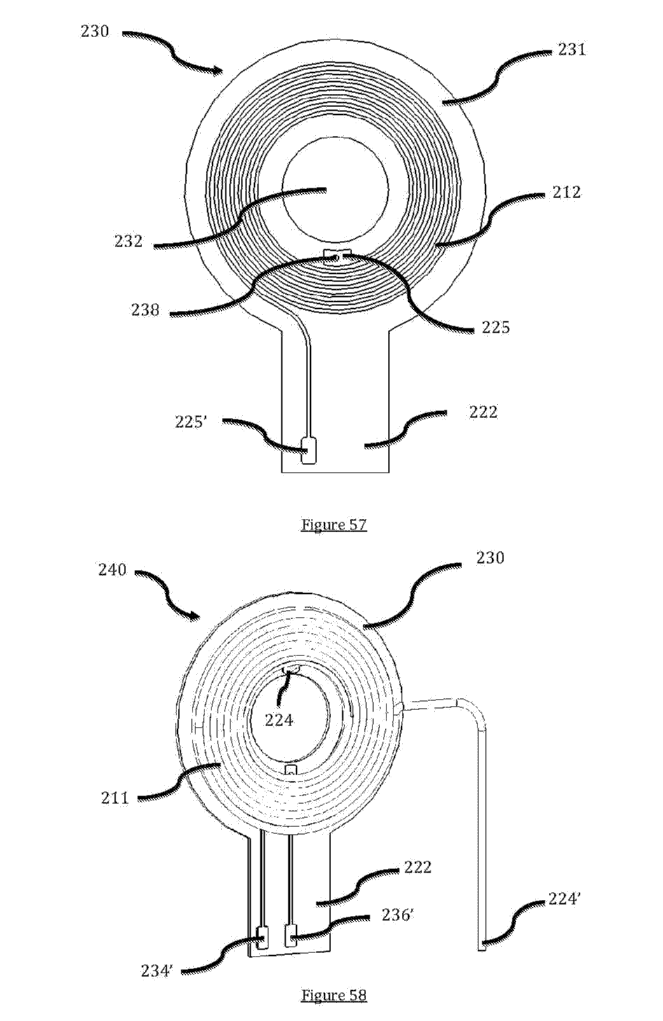

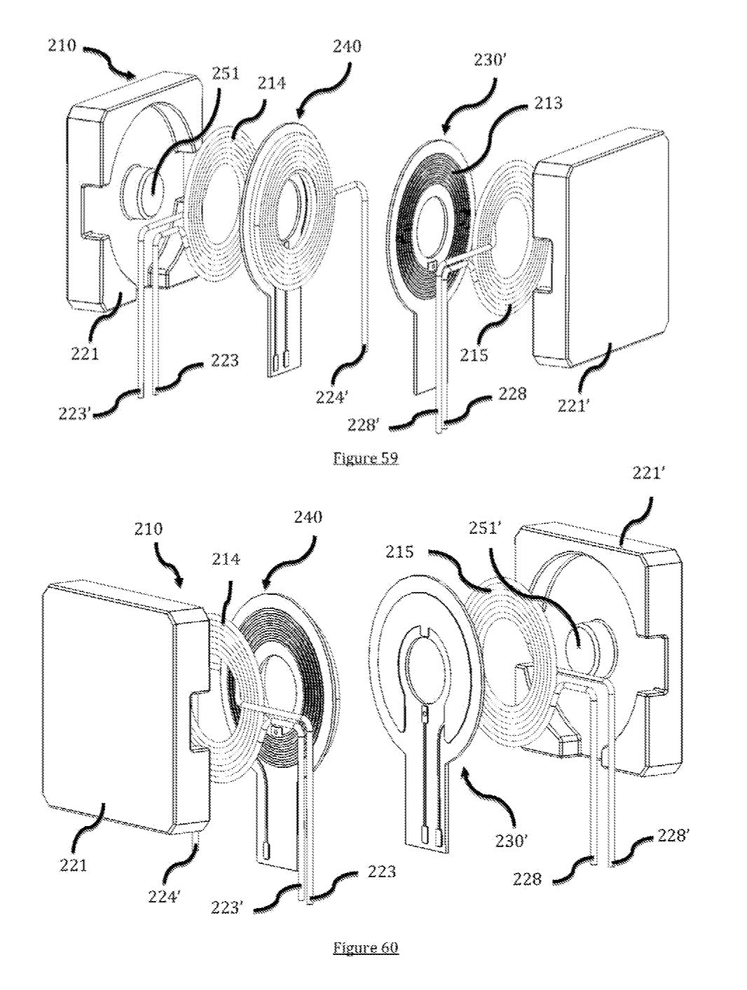

FIGS. 44 to 52 show a typical construction of transformer 180 of this embodiment. Depending on the choice of ferrites, which can be rectangular, circular or any other practical shapes, the insulator and winding shapes are accommodated accordingly to allow all parts to be aligned and assembled together properly to form a transformer.

FIGS. 44 to 52 show a transformer 180 including two rectangular shape ferrite halves 185, 185′ each with a respective rectangular ferrite core center 201, 201′. A single slotted bobbin 191 has an optional extended part 186 for connecting one end of an auxiliary winding 187 to the interface component, preferably to be the main power supply board which is not shown in the drawings, of the power supply board (not shown).

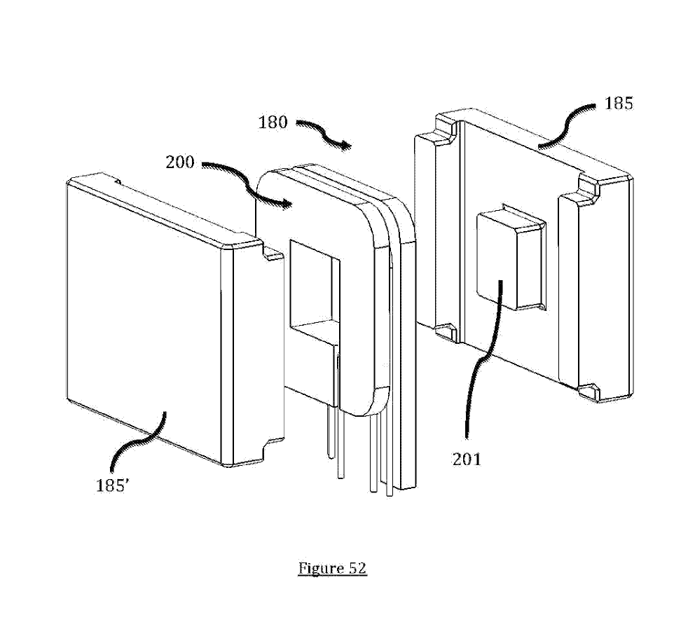

The auxiliary winding 182 that forms the shield winding is printed, usually in spiral shape, by using conductive material, on one side of the slotted bobbin 191. One winding end 187 of the auxiliary winding 182 is located at the optional extended bobbin part 186 for external interface connection purpose. Another winding end 187′ of the auxiliary winding 182 is located at the inner spiral. The winding end 187′ is electrically connected to a terminal end 189′ of an electrical conductor 193. The conductor 193 runs along the slot of the inner core of the bobbin 191 to the opposite side of the printed auxiliary winding 182 as shown in FIGS. 48 and 49, and is terminated at a point 189 for connecting to the external electrical interface component (not shown) of the power supply board (not shown).

The primary winding 181, which is usually wound with safety approved enamel wire, is wound along the slot of the one slotted bobbin 191, and has two terminal pins 188, 188′. With the primary winding 181 wound in the bobbin slot of bobbin 191 and the auxiliary winding 182 printed on one side of the bobbin 191, it forms the primary wound bobbin 195 as shown in FIG. 47.

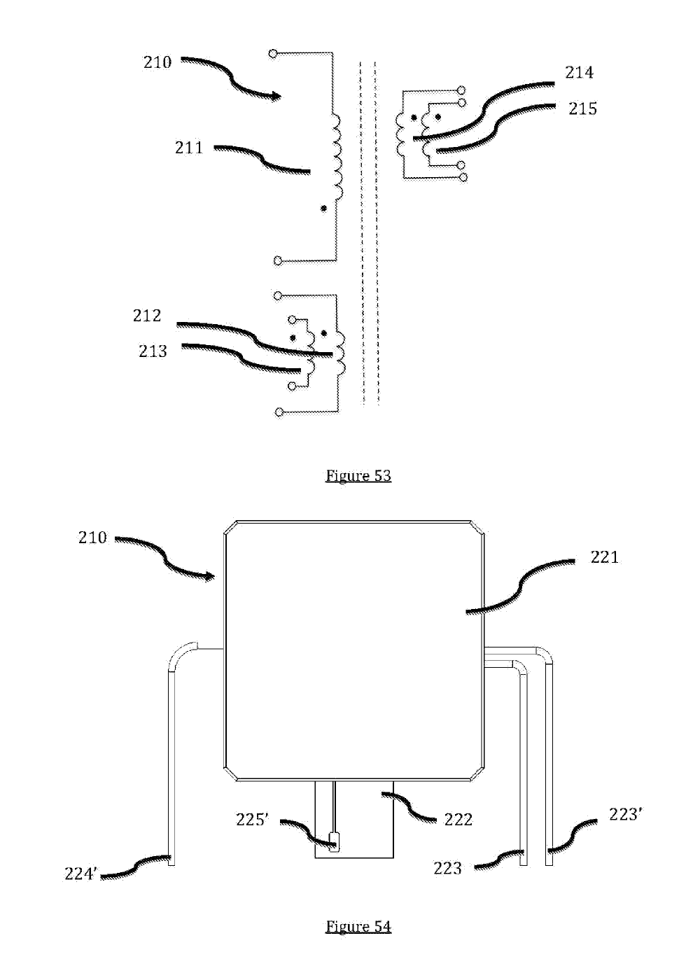

The secondary winding 183 (also as the secondary interface winding in this embodiment as it is of a one-layer winding construction), which is usually wound by safety approved triple insulation wire for safety insulation purpose, is preferably wound in spiral shape in one layer only but can be multi-layer if necessary. The secondary winding 183 is attached as close as possible to the side of the one slotted bobbin 181 having the auxiliary winding 182 (also as the primary interface winding in this embodiment) printed on it. With the secondary winding 183 attached to the primary wound bobbin 195 as shown in FIG. 50 it forms the winding assembly 200. The winding ends 190, 190′ are preferably extended freely and terminate directly to the electrical interface component (not shown) of the power supply board (not shown).

For best noise cancellation or noise reduction performance, the number of turns and shape of the auxiliary winding 182 together with the secondary interface winding (which is the secondary winding 183 in this embodiment) are preferably designed and assembled such that the interface voltage swing or noise between the two windings is below a predefined desirable level.

In brief the construction of Embodiment 9 is the winding assembly 200 sandwiched by the two ferrite halves 185, 185′. All the parts are fixed together by proper adhesive or fixing materials (not shown) during the manufacturing process.

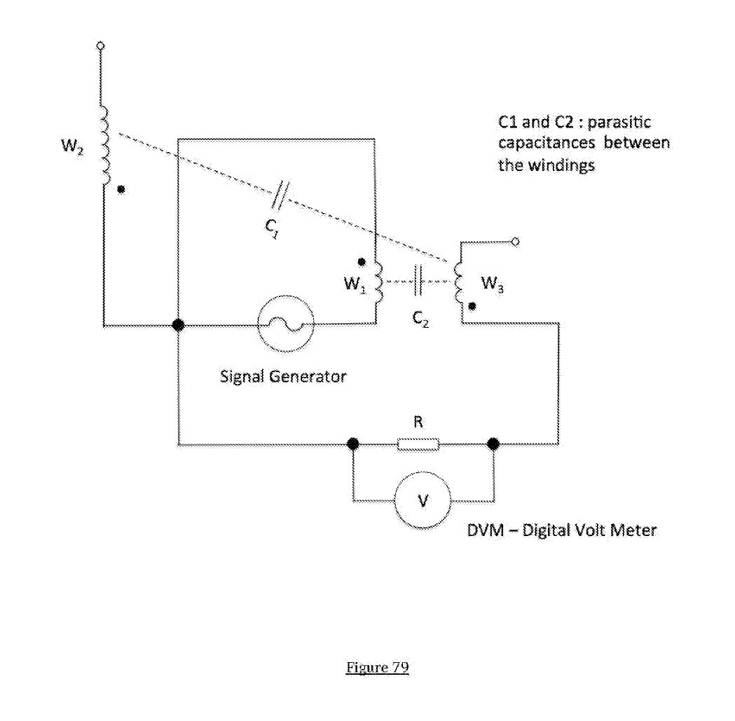

FIG. 78 shows a schematic diagram of a very simple flyback switching power supply transformer, in which W1 is a primary winding, W2 is an auxiliary winding and W3 is a secondary winding. FIG. 79 shows one method of determining whether the interface voltage swing or noise between two windings in the transformer shown in FIG. 78 is below a predefined desired level. In particular, one checks the electric voltage across the resistor R. The noise reduction effect is considered to be acceptable as long as the voltage across the resistor R is below a predefined desired threshold value.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

What is claimed is:

1. A transformer including:
at least one primary interface winding, and
at least one secondary interface winding,
wherein at least part of said primary interface winding is formed on an insulating device or insulator, and
wherein at least part of said primary interface winding and at least part of said secondary interface winding collectively form a noise reduction mechanism.

2. The transformer according to claim 1 wherein said primary interface winding includes at least part or the whole of a primary winding and/or at least part or the whole of an auxiliary winding.

3. The transformer according to claim 1 wherein said secondary interface winding includes at least part or the whole of a secondary winding.

4. The transformer according to claim 1 wherein said primary interface winding includes at least one layer of common mode noise reduction coil, wherein said secondary interface winding includes at least one layer of coil, wherein the number of turn(s) of coil of said primary interface winding is from substantially 80% to substantially 120% of the number of turn(s) of coil of said secondary interface winding, and wherein said primary interface winding interfaces with and is located adjacent to said secondary interface winding.

5. The transformer according to claim 1 wherein a bobbinless coil is attached next to the primary interface winding.

6. The transformer according to claim 1 wherein the interface voltage swing between said primary interface winding to a corresponding layer of said secondary interface winding is matched below a pre-determined level.

7. The transformer according to claim 1 wherein said insulator includes a first side, an opposite second side with printed circuit traces or noise shielding pattern on at least one of said first and second sides, wherein at least one of said interface windings is attached to one of said first and second sides of the said insulator.

8. The transformer according to claim 1 wherein said insulator includes a printed wiring board.

9. The transformer according to claim 4 wherein at least one of said interface windings is encapsulated inside a plastic or resin molding.

10. The transformer according to claim 9 wherein a bobbinless coil is attached to said plastic or resin molding.

11. The transformer according to claim 9 further including at least one extended part with printed conductive terminals allowing direct soldering of at least one electrical connection on said molding onto a main board.

12. The transformer according to claim 1 further including at least one extended part with printed conductive terminals allowing direct soldering of at least one electrical connection on said insulator onto a main board.

13. The transformer according to claim 1 wherein the at least one primary winding is wound on a slotted bobbin.

14. The transformer according to claim 13 wherein said bobbin includes a first side and an opposite second side, and wherein a conductive material is printed on one or both sides of said bobbin to form a winding coil or noise shield.

15. The transformer according to claim 13 wherein a bobbinless coil is attached to one side or both sides of the said bobbin.

16. The transformer according to claim 1 wherein said at least part of said primary interface winding is formed on an insulating device or insulator by printing, etching and/or engraving.
